(19) United States
(12) Patent Application Publication
(10) Pub. No.: US 2016/0110432 A1
(43) Pub. Date: Apr. 21, 2016

(54) RECORDING MEDIUM STORING SEARCH RESULT DISPLAY PROGRAM, INFORMATION PROCESSING DEVICE, AND SEARCH RESULT DISPLAYING METHOD

(71) Applicant: FUJITSU LIMITED, Kawasaki-shi (JP)

(72) Inventors: YOSHIRO MUNESADA, Kawasaki (JP); Kai TAMURA, Yokohama (JP)

(21) Appl. No.: 14/844,081

(22) Filed: Sep. 3, 2015

(30) Foreign Application Priority Data
Oct. 17, 2014 (JP) 2014-212587

(51) Int. Cl. G06F 17/30; G06F 3/0484; G06F 3/0488; G06F 3/0482

(52) U.S. Cl. CPC G06F 17/30554; G06F 17/3053; G06F 3/0482; G06F 3/04842; G06F 3/04883; G06F 3/04886

(57) ABSTRACT

In a state in which, in a sectional region s, search result display region t is disposed at a side opposite a key information display region side of search result display region t+1 along an arrayed direction of a plurality of search result display regions that are included in the sectional region s, and, in a state in which search result of ranking m is displayed in the search result display region t of the sectional region s, and search result of ranking m+1 is displayed in the search result display region t+1 of the sectional region s, when a first touch operation is detected, the search result of ranking m+1 is displayed in the search result display region t of the sectional region s, and search result of ranking m+2 is displayed in the search result display region t+1 of the sectional region s.

### CROSS-REFERENCE TO RELATED APPLICATION

This application is based upon and claims the benefit of priority of the prior Japanese Patent Application No. 2014-212587, filed on Oct. 17, 2014, the entire contents of which are incorporated herein by reference.

### FIELD

The technique of the disclosure relates to a recording medium storing a search result display program, an information processing device and a search result displaying method.

### BACKGROUND

There is a technique in which images are searched for by using a randomly selected key, and retrieved images are displayed so as to be lined-up in a vertical direction, and an image, that is selected from among the retrieved images, is moved to the center of the screen and displayed in an enlarged manner as a main image. In this technique, images are searched for by using a key selected from the main image, and, on the basis of the degree of association with the main image, or the like, the retrieved images are displayed so as to be lined-up in the lateral direction. The key that is selected from the main image is, for example, the time of photographing or the photographing time period such as morning, forenoon, afternoon, evening or the like, or the world time of the time of the photographing, or the exposure, sensitivity, storage size or storage quality, or the color or the white balance that the recognized image has, or the names, characteristics, or number of recognized persons, or the like. By changing the main image, the vague search requirements of the user become more clear.

### RELATED PATENT DOCUMENTS

Japanese Patent Application Laid-Open (JP-A) No. 2008-90365

JP-A No. 2007-226536

JP-A No. 8-329096

Japanese Patent Application National Publication No. 2010-503130

### SUMMARY

According to an aspect of the embodiments, a non-transitory recording medium storing a search result display program that causes a computer, that has a first storage section that stores information in which rankings of search results, types of searches and search results are set in respective correspondence with one another, to execute a process. The process includes: displaying on a display section a search result display screen that includes a key information display region that displays information relating to key information, and a plurality of sectional regions that are disposed at a periphery of the key information display region and that respectively include a plurality of search result display regions arrayed along radial directions that differ from one another; storing, in the first storage section, search results of a plurality of types of searches that have been carried out on the basis of the key information; displaying, in search result display regions of the sectional regions that correspond to types of searches, search results whose search result rankings are n, wherein n is an integer; and in a state in which, in a sectional region s, search result display region t, wherein t is an integer, is disposed at a side opposite the key information display region side of search result display region t+1 along an arrayed direction of the plurality of search result display regions that are included in the sectional region s, and, in a state in which search result of ranking m, wherein m is an integer, is displayed in the search result display region t of the sectional region s, and search result of ranking m+1 is displayed in the search result display region t+1 of the sectional region s, when a first touch operation is detected, displaying the search result of ranking m+1, that was read-out from the first storage section, in the search result display region t of the sectional region s, and displaying search result of ranking m+2, that was read-out from the first storage section, in the search result display region t+1 of the sectional region s.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of main functions of a smart device relating to an embodiment;

FIG. 2 is a schematic drawing illustrating an example of search result tables relating to the embodiment;

FIG. 3 is a schematic drawing illustrating an example of a search result management table relating to the embodiment;

FIG. 4 is a block diagram illustrating an example of the structure of the electrical system of the smart device relating to the embodiment;

FIG. 5 is a schematic drawing illustrating an example of a search result display screen relating to the embodiment;

FIG. 6 is a flowchart illustrating an example of search result displaying processing relating to the embodiment;

FIG. 7A is a schematic drawing illustrating an example of a start-up screen relating to the embodiment;

FIG. 7B is a schematic drawing illustrating an example of a search result display screen relating to the embodiment;

FIG. 7C is a schematic drawing illustrating an example of a search result display screen relating to the embodiment;

FIG. 7D is a schematic drawing illustrating an example of a screen that includes enlarged display of an image relating to the embodiment;

FIG. 7E is a schematic drawing illustrating an example of a screen that displays a webpage relating to the embodiment;

FIG. 7F is a schematic drawing illustrating an example of a search result display screen relating to the embodiment;

FIG. 8 is a flowchart illustrating an example of searching processing relating to the embodiment;

FIG. 9 is a flowchart illustrating an example of text searching processing relating to the embodiment;

FIG. 10 is a flowchart illustrating an example of similar image searching processing relating to the embodiment;

FIG. 11 is a flowchart illustrating an example of recommended searching processing relating to the embodiment;

FIG. 12 is a flowchart illustrating an example of similar user searching processing relating to the embodiment;

FIG. 13 is a flowchart illustrating an example of search result screen displaying processing relating to the embodiment;

FIG. 14A is a schematic drawing illustrating an example of a search result display screen relating to the embodiment;

FIG. 14B is a schematic drawing illustrating an example of a search result display screen relating to the embodiment;

FIG. 14C is a schematic drawing illustrating an example of a search result display screen relating to the embodiment;

FIG. 15 is a table illustrating an example of the relationship between search result display regions and displayed contents relating to the embodiment;

FIG. 16 is a table illustrating an example of the relationship between search result display regions and displayed contents relating to the embodiment;

FIG. 17A is a schematic drawing illustrating an example of a search result display screen relating to the embodiment;

FIG. 17B is a schematic drawing illustrating an example of a search result display screen relating to the embodiment;

FIG. 17C is a schematic drawing illustrating an example of a search result display screen relating to the embodiment;

FIG. 18 is a table illustrating an example of the relationship between search result display regions and displayed contents relating to the embodiment;

FIG. 19A is a schematic drawing illustrating an example of a search result display screen relating to the embodiment;

FIG. 19B is a schematic drawing illustrating an example of a search result display screen relating to the embodiment;

FIG. 19C is a schematic drawing illustrating an example of a search result display screen relating to the embodiment;

FIG. 20 is a schematic drawing for explaining an example of linking of searches relating to the embodiment;

FIG. 21A is a schematic drawing illustrating an example of a search result display screen relating to the embodiment;

FIG. 21B is a schematic drawing illustrating an example of a search result display screen relating to the embodiment;

FIG. 21C is a schematic drawing illustrating an example of a search result display screen relating to the embodiment;

FIG. 22 is a table illustrating an example of the relationship between search result display regions and displayed contents relating to the embodiment;

FIG. 23 is a schematic drawing illustrating an example of a search result display screen relating to the embodiment;

FIG. 24 is a schematic drawing illustrating examples of a search result display screen relating to the embodiment being applied to various devices;

FIG. 25 is a schematic drawing illustrating an example of a search result display screen relating to the embodiment;

FIG. 26 is a block diagram illustrating an example of main functions of a smart device relating to the embodiment;

FIG. 27 is a block diagram illustrating an example of the structure of the electrical system of the smart device relating to the embodiment;

FIG. 28A is a schematic drawing illustrating an example of a search result display screen relating to the embodiment;

FIG. 28B is a schematic drawing illustrating an example of a search result display screen relating to the embodiment;

FIG. 28C is a schematic drawing illustrating an example of a search result display screen relating to the embodiment;

FIG. 28D is a schematic drawing illustrating an example of a search result display screen relating to the embodiment; and

FIG. 28E is a schematic drawing illustrating an example of a search result display screen relating to the embodiment.

### DESCRIPTION OF EMBODIMENTS

An example of an embodiment of the technique of the disclosure is described in detail hereinafter with reference to the drawings.

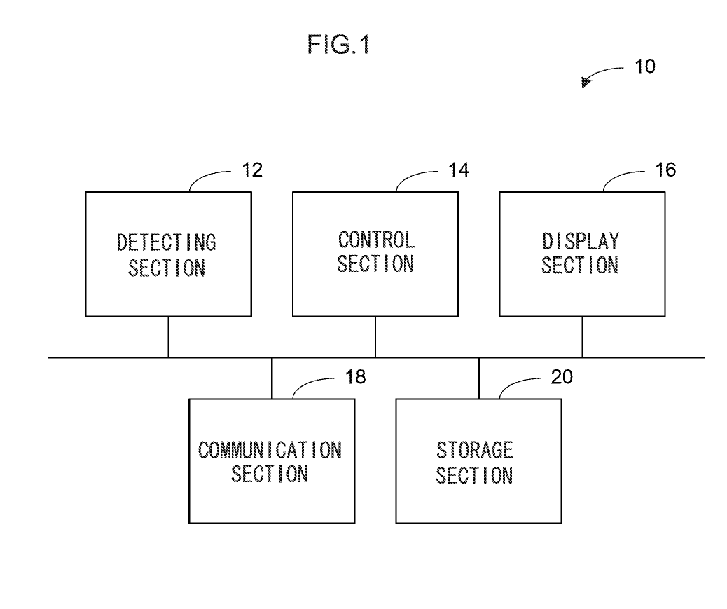

A smart device 10 that is illustrated as an example in FIG. 1 includes a searching section 12, a control section 14, a display section 16, a communication section 18 and a storage section 20. The searching section 12, the control section 14, the display section 16, the communication section 18 and the storage section 20 are connected to one another.

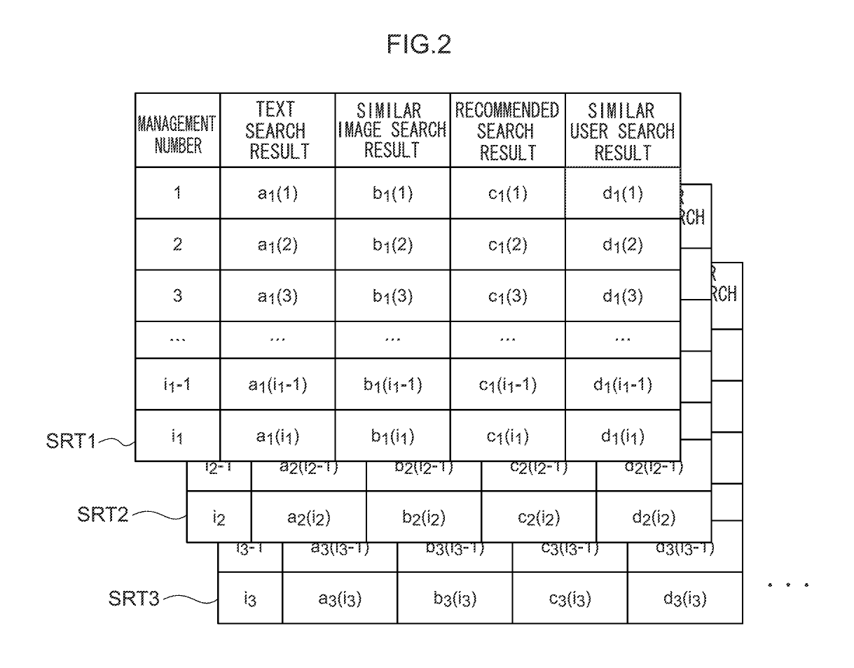

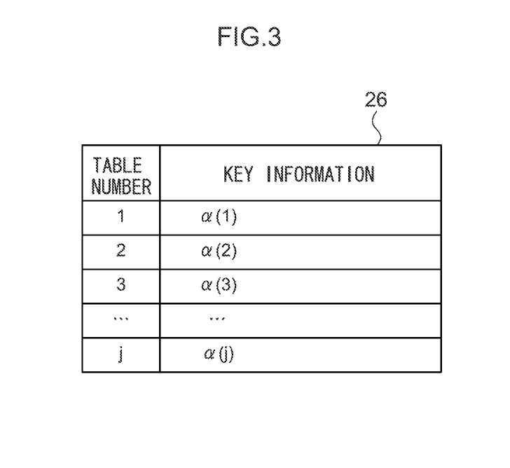

The storage section 20 stores search result tables SRT1, SRT2, SRT3, . . . , SRTj (hereinafter also called search result tables SRT, and j indicates the table number) that are illustrated as examples in FIG. 2, and a search result managing table 26 that is illustrated as an example in FIG. 3. The search result table SRT stores URLs (Uniform Resource Locators) of webpages that are search results, in correspondence with management numbers 1₁, 2₁, 3₁, . . . , i₁, . . . that express the rankings of the search results, per type of search. Note that the subscripts of the management numbers express the table number, and the number to which the subscript is applied expresses the ranking of the search result. For example, management number 3₁ expresses that this is a search result whose ranking in the search results of search result table SRT1 is third. The table number expresses the order of the searches that have been carried out in the past (the order of the search history). Further, FIG. 2 illustrates a case in which the number of search results in each search table is the same, but the number of search results may differ per search result table. Note that, in the following description, for convenience of explanation, description is given by using, as the management numbers, numbers that express only the search rankings and to which subscripts are not applied. Further, the search result managing table 26 stores key information in correspondence with the table number of the search result table SRT. Note that the search result table SRT is generated each time a search is carried out. Types of searches are, for example, text searches, similar image searches, recommended searches and similar user searches that are described later.

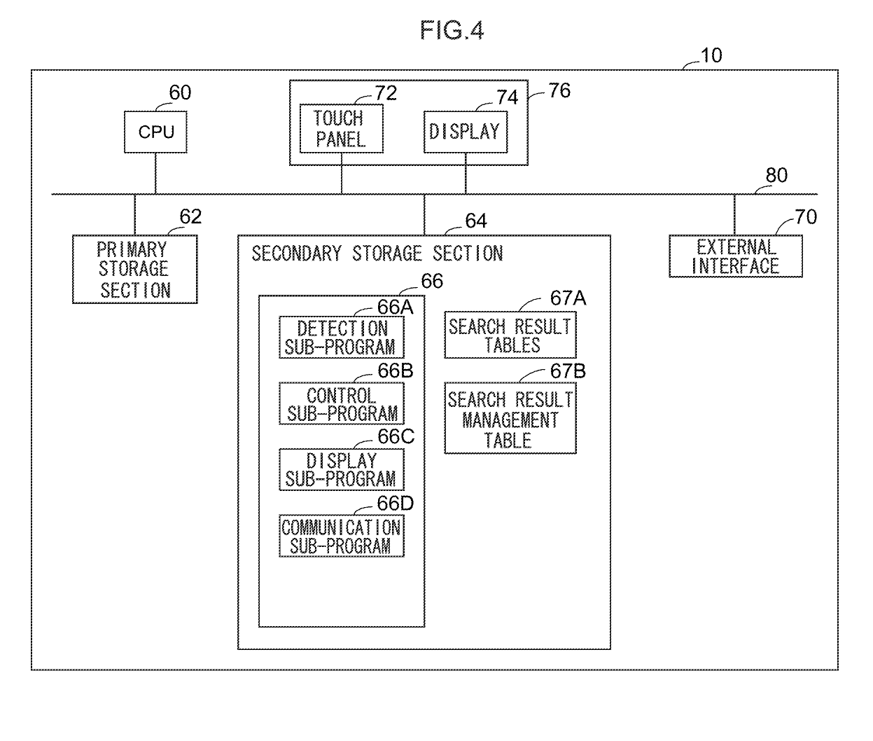

As illustrated as an example in FIG. 4, the smart device 10 includes a CPU (Central Processing Unit) 60, a primary storage section 62, a secondary storage section 64, an external interface 70 and a touch panel display 76. The touch panel display 76 includes a touch panel 72 and a display 74. The CPU 60, the primary storage section 62, the secondary storage section 64, the external interface 70 and the touch panel display 76 are connected to one another via a bus 80.

The touch panel 72 detects touch operations with respect to the touch panel 72. The display 74 displays a search result display screen and the like. An external device is connected to the external interface 70, and the external interface 70 covers the transmission and receiving of various types of information between the external device and the CPU 60.

The primary storage section 62 is a volatile memory such as a RAM (Random Access Memory) or the like for example. The secondary storage section 64 is a non-volatile memory such as an HDD (Hard Disk Drive) or an SSD (Solid State Drive) or the like for example.

As an example, the secondary storage section 64 stores a search result display program 66 that includes a detection sub-program 66A, a control sub-program 66B, a display sub-program 66C and a communication sub-program 66D. The CPU 60 reads-out the detection sub-program 66A, the control sub-program 66B, the display sub-program 66C and the communication sub-program 66D from the secondary storage section 64, and expands the sub-programs in the primary storage section 62.

By executing the detection sub-program 66A, the CPU 60 operates as the detection section 12 illustrated in FIG. 1. By executing the control sub-program 66B, the CPU 60 operates as the control section 14 illustrated in FIG. 1. By executing the display sub-program 66C, the CPU 60 operates as the display section 16 illustrated in FIG. 1. By executing the communication sub-program 66D, the CPU 60 operates as the communication section 18 illustrated in FIG. 1. Note that the search result display program 66 is an example of the program relating to the technique of the disclosure.

Further, the secondary storage section 64 stores data 67A that generates the search result table, and data 67B that generates the search result management table. The primary storage section 62 and the secondary storage section 64 correspond to the storage section 20 of FIG. 1.

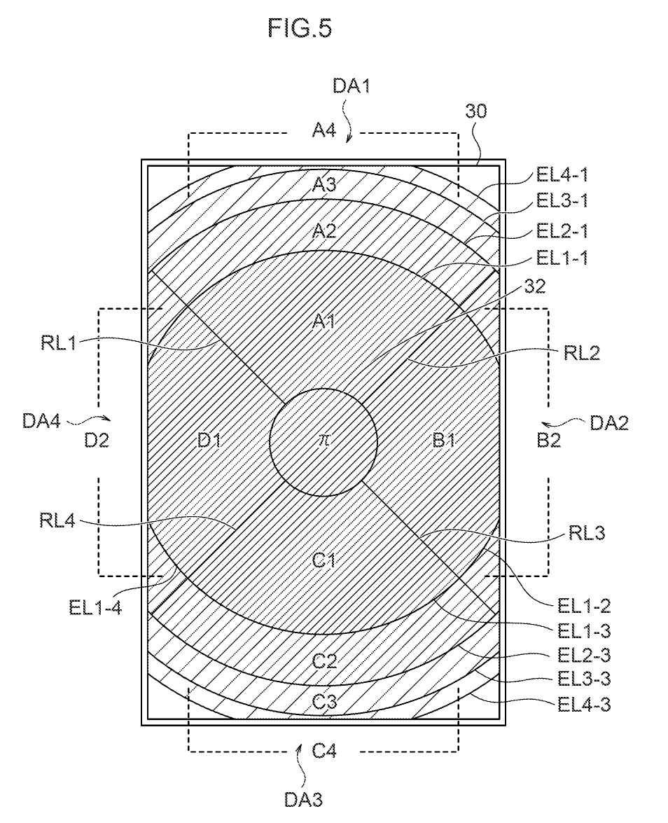

An example of a search result display screen 30 relating to the present embodiment is illustrated in FIG. 5. The search result display screen 30 is sectioned, by a circle that is displayed at the central portion of the search result display screen 30, into a key information display region π that is circular and is the region at the inner side of the circle, and a region at the outer side of the key information display region π. The region at the outer side of the key information display region π is sectioned by four, radial sectioning lines RL1˜RL4 into four sectional regions DA1˜DA4.

The respective sectioning lines RL1˜RL4 extend in a radial form from the center of the key information display region π, with the origins thereof being points of respectively different positions on the circumference of the key information display region π. Respective extension lines of the four sectioning lines RL1˜RL4 intersect the extension lines of the adjacent sectioning lines at 90° angles.

Accordingly, the sectional regions DA1˜DA4 are disposed along respectively different radial directions at the periphery of the key information display region π.

The sectional region DA1 is sectioned into four search result display regions A1, A2, A3, A4 by borderlines EL1-1, EL2-1, EL3-1, EL4-1 that are four arcs that are coaxial with the center of the key information display region π and whose radii differ from one another. The radii of the arcs are determined such that, the further away from the key information display region it, the smaller the difference between the radii of adjacent arcs gradually becomes.

Accordingly, the radial direction width of search result display region A1, that is surrounded by contour line 32 of the key information display region π and the sectioning lines RL1, RL2 and the borderline EL1-1, is the greatest among A1˜A4. Further, the radial direction widths of the search result display regions gradually become smaller while heading toward the search result display region A2, the search result display region A3, the search result display region A4 and the outer side.

The respective sectional regions DA2˜DA4 also are each sectioned into four search result display regions by four arcs that are coaxial with the center of the key information display region π and respectively have the same radii as the four arcs EL1-1, EL2-1, EL3-1, EL4-1 that section the sectional region DA1. The sectional region DA2 is sectioned by four arcs EL1-2, EL2-2, EL3-2, EL4-2 into four search result display regions B1, B2, B3, B4. Note that, in FIGS. 5, B3 and B4 are positioned outside of the screen, but, in terms of data, processing is carried out while assuming that B3 and B4 exist. Further, the sectional region DA3 is sectioned by four arcs EL1-3, EL2-3, EL3-3, EL4-3 into four search result display regions C1, C2, C3, C4. Further, the sectional region DA4 is sectioned by four arcs EL1-4, EL2-4, EL3-4, EL4-4 into four search result display regions D1, D2, D3, D4. Note that, in FIGS. 5, D3 and D4 are positioned outside of the screen, but, in terms of data, processing is carried out while assuming that D3 and D4 exist.

It suffices for at least some of the sectional regions DA1˜DA4 or search result display regions A1˜D4 to be displayed on the touch panel display 76, and the key information display region π may be displayed at a position apart from the center of the touch panel display 76. In FIG. 5, the search result display regions B3, B4, D3 and D4 exist on a theoretical screen, but, because the shape of the touch panel display 76 is rectangular, the search result display regions B3, B4, D3 and D4 are not displayed in FIG. 5. Further, borderlines EL2-2, EL3-2, EL4-2, EL2-4, EL3-4, EL4-4 also are not displayed in FIG. 5.

Description and images (hereinafter also called display data), that are included in the webpages indicated by the URLs that are stored in the data 67A that generates the search result table, are respectively displayed in the search result display regions A1˜D4 of the sectional regions DA1˜DA4 that differ per type of search.

Description describes the contents of a webpage by meta tags such that a search engine or the like can appropriately grasp the contents of the webpage. Meta tags are tags that are located in the head elements of an HTML document, and are tags that designate the language or character encoding in which the page is written, and describe keywords or explanatory text or the like. Meta tags are usually not displayed on the screen of the browser in which the webpage is displayed.

The search result display screen 30 may be displayed such that, the further the search result display region is to the outer side, the lighter the color of the display is as compared with the search result display region at the inner side, or, the further the search result display region is to the outer side, the more the sharpness, saturation or brightness is lowered as compared with the search result display region at the inner side. Due thereto, the interest of the user can be gathered toward the search result display regions A1, B1, C1, D1 that are further toward the inner side.

In accordance with a touch operation of the user on the touch panel display 76, display data that has not been displayed is displayed in the search result display regions A1, B1, C1, D1. The display positions of the display data, that were displayed in the search result display regions A1, B1, C1, D1, are moved to the search result display regions A2, B2, C2, D2.

Further, in accordance with a touch operation of the user that is different than the above-described touch operation on the touch panel display 76, the display data that are displayed in the search result display regions A1, B1, C1, D1 are deleted. The display positions of the display data, that were displayed in the search result display regions A2, B2, C2, D2, are respectively moved to the search result display regions A1, B1, C1, D1.

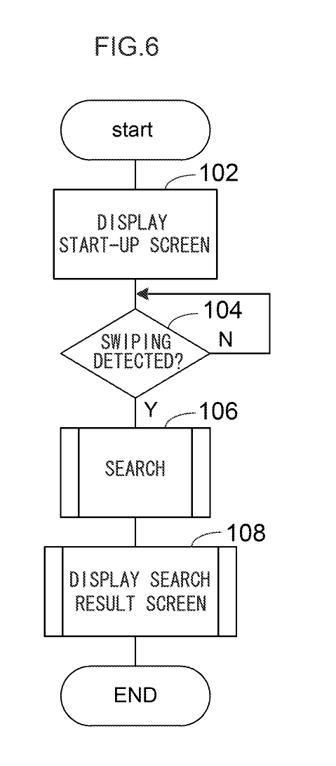

Next, search result displaying processing, that is carried out by the smart device 10 due to the CPU 60 executing the search result display program 66, is described as operation of the present embodiment and with reference to FIG. 6.

The search result displaying processing is started due to, for example, a user tapping on a button or the like that is displayed on the touch panel display 76 of the smart device 10.

As an example, the search result displaying processing of the present embodiment is started-up in a state in which the user is logged-into a social networking service or a portal site or the like. Due thereto, the search result displaying processing of the present embodiment can utilize, in searching, the information relating to the user that is accumulated in the social networking service or portal site or the like.

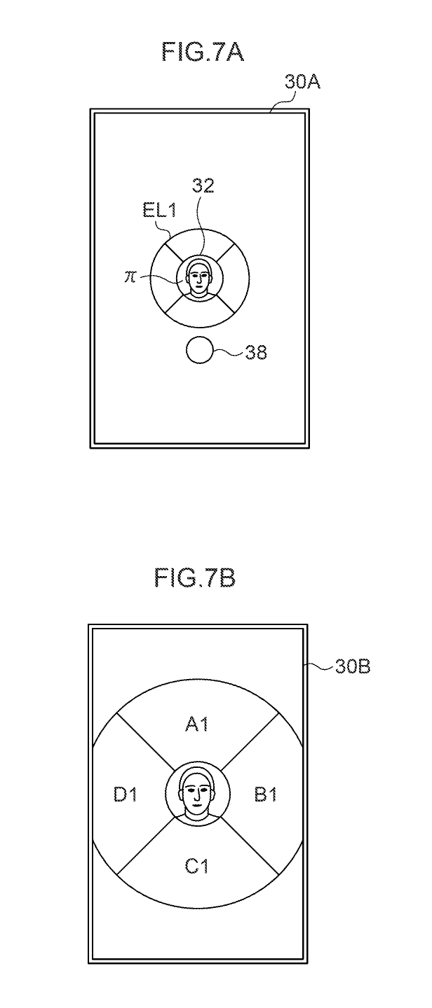

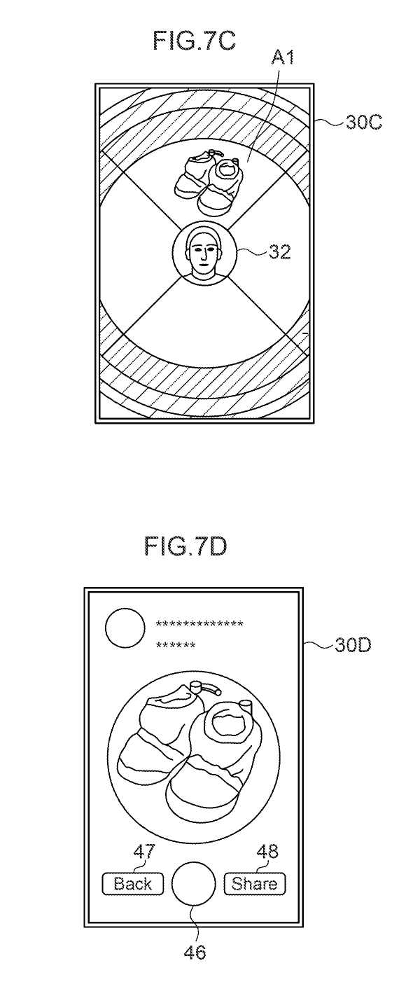

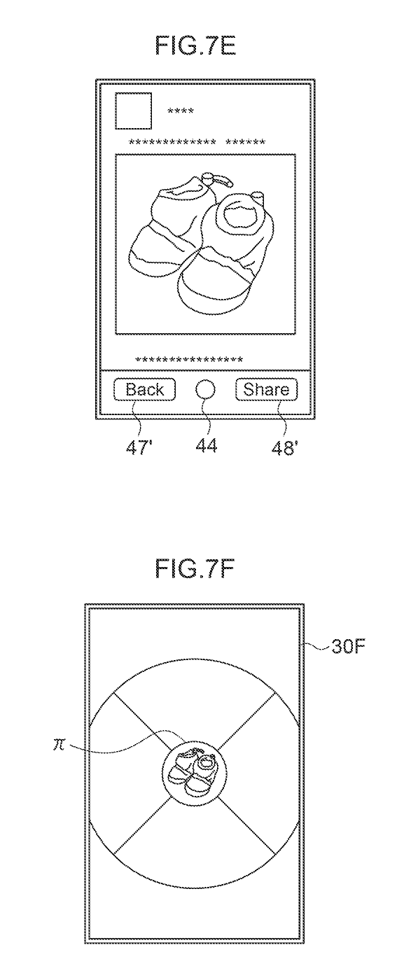

In step 102 of FIG. 6, the CPU 60 displays a start-up screen 30A, that illustrates an example in FIG. 7A, on the touch panel display 76. The key information display region π is displayed in the center of the start-up screen 30A, and an image relating to key information is displayed in the key information display region π. In the initial state, the key information is, for example, information, e.g., a URL, that indicates the accumulated place of information that relates to the user and is accumulated in the social networking service or the portal site or the like, and the image relating to the key information is the profile image of the user. Note that, in the present embodiment, the image that relates to the key information may be the image of the largest size that is included in the webpage indicated by the URL that is the key information, or may be an image that has been recently shared, or the like. Further, for example, text data, image data, URL data and the like are included in the information relating to the user.

Further, a circle 38 that induces the user to place his/her finger thereon is displayed beneath the key information display region π. Further, in the start-up screen 30A, the display position of the circle 38 exhibits the motions of moving further downward and returning. Further, together therewith, an animation is displayed in which the borderlines EL1-1, EL1-2, EL1-3, EL1-4 (hereinafter also called borderlines EL1; the same holds for EL2 through EL4 as well) exhibit motions in which the interval between itself and the contour line 32 of the key information display region π widens and returns. Due thereto, it is suggested to the user that searching will be started by swiping the touch panel display 76 downward. Note that the swiping may be clicking.

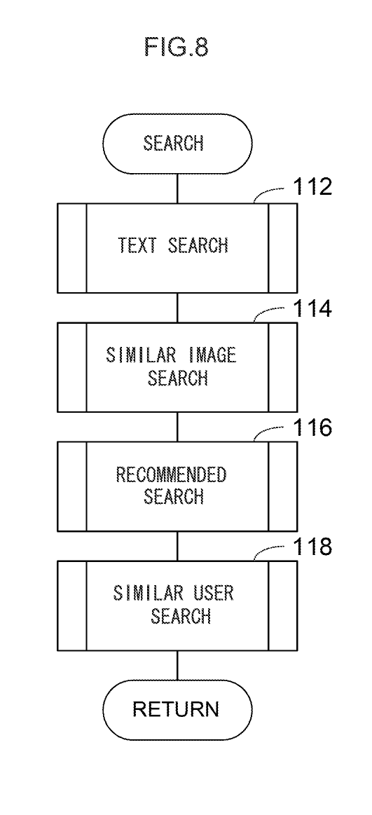

In step 104 of FIG. 6, the CPU 60 judges whether or not the finger of the user has swiped the touch panel display 76 downward. Step 104 is repeated until the judgment is affirmative. When it is detected that the finger of the user has swiped the touch panel display 76 downward, the judgment in step 104 becomes affirmative, and the CPU 60 moves on to step 106. In step 106, the CPU 60 carries out the searching processing that is illustrated in detail in FIG. 8.

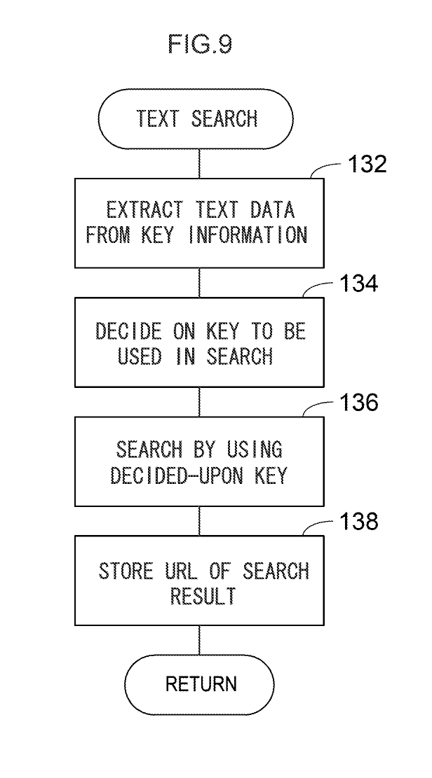

In step 112 of FIG. 8, the text searching processing that is illustrated in detail in FIG. 9 is carried out. In step 132 of FIG. 9, the CPU 60 extracts text data from the webpage indicated by the URL that is the above-described key information. In step 134, the CPU 60 decides on a key, that is to be used in searching, from among the extracted text data. For example, it is possible to decide on text having a high degree of importance as the key that is to be used in searching. Text having a high degree of importance are, for example, text that is used in the title, text whose font size is large, linked text, text of a different color than the text at the periphery thereof, text of a different style than the text at the periphery thereof, and the like. Further, for example, text that is included in the meta tags, or the like, is text having a high degree of importance.

In step 136, by using the key that has been decided upon, the CPU 60 utilizes a search engine provided on the internet, and carries out searching from data existing on the internet. Note that an intranet or another network may be used instead of the internet. In step 138, the CPU 60 acquires a URL extracted in the search, and stores the URL in the text search result column of the search result table SRT in order in the order of the search results.

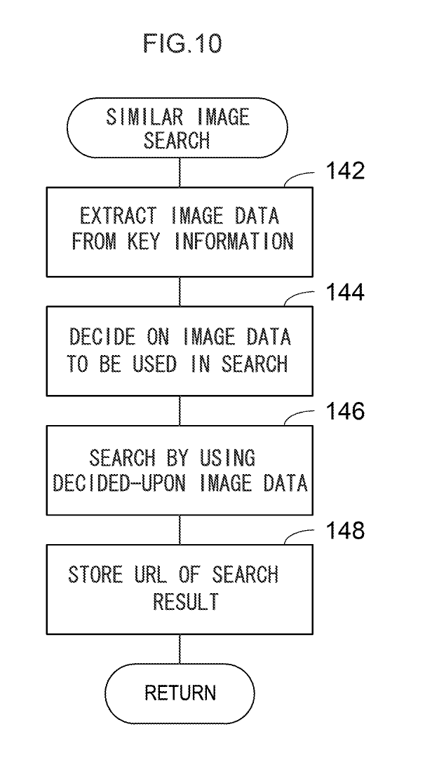

In step 114 of FIG. 8, the similar image searching processing that is illustrated in detail in FIG. 10 is carried out. In step 142 of FIG. 10, the CPU 60 extracts image data from the webpage indicated by the URL that is the above-described key information. In step 144, the CPU 60 decides on an image, that is to be used in searching, from among the extracted image data. An image having a high degree of importance such as, for example, the image having the largest display size, an OGP (Open Graph Protocol) image, an image that was shared recently, or the like, can be decided on as the image data to be used in searching.

An OGP image is an image that is set in advance as an image that is displayed in a case of sharing on a social networking service or the like.

In step 146, the CPU 60 uses the image data that was decided-upon, and utilizes a search engine having a similar image search function that is provided on the internet, and carries out similar image searching. In step 148, the CPU 60 acquires a URL extracted in the search, and stores the URL in the similar image search result column of the search result table SRT in order in the order of the search results.

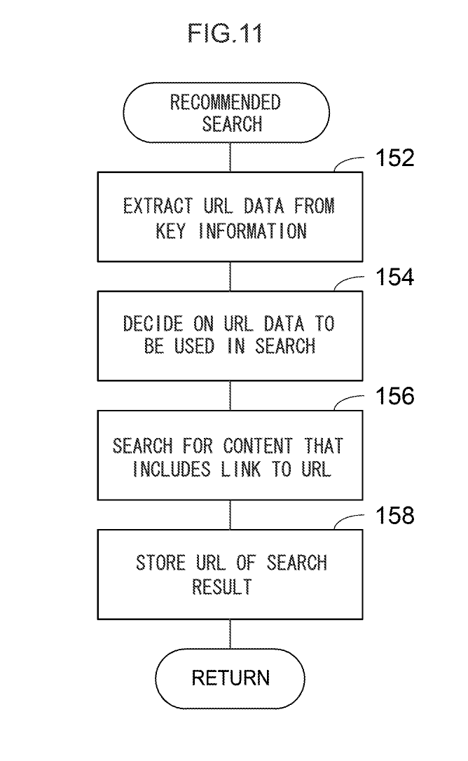

In step 116 of FIG. 8, the recommended search processing that is illustrated in detail in FIG. 11 is carried out. In step 152 of FIG. 11, the CPU 60 extracts URL data from the webpage indicated by the URL that is the above-described key information. In step 154, the CPU 60 decides on URL data, that is to be used in searching, from among the extracted URL data. For example, URL data displayed by text whose font size is large, text of a different color than the text at the periphery thereof, or text of a different style than the text at the periphery thereof can be decided upon as the URL data to be used in searching.

In step 156, by using a search engine provided on the internet, the CPU 60 searches for a webpage containing a link to the URL expressed by the URL data that was decided-upon. In step 158, the CPU 60 acquires the URL of a webpage extracted in the search, and stores the URL in the recommended search result column of the search result table SRT in order in the order of the search results.

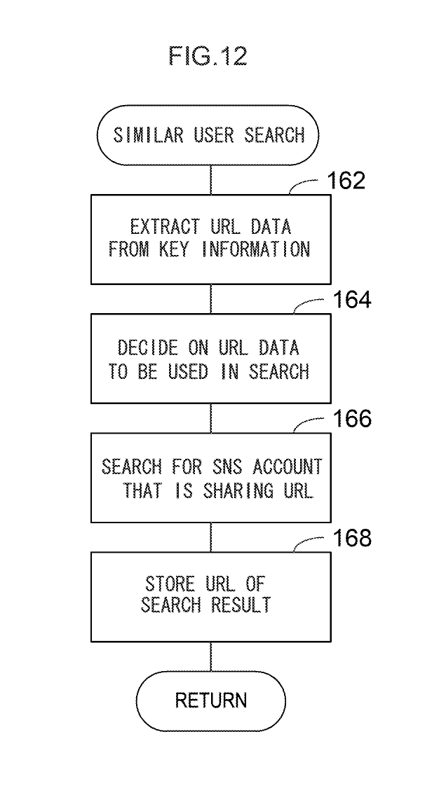

The similar user search processing, that is illustrated in detail in FIG. 12, are illustrated in step 118 of FIG. 8. In step 162 of FIG. 12, the CPU 60 extracts URL data from the webpage indicated by the URL that is the key information. In step 164, the CPU 60 decides on URL data, that is to be used in searching, from among the extracted URL data. URL data having a high degree of importance that is displayed by, for example, text whose font size is large, text of a different color than the text at the periphery thereof, or text of a different style than the text at the periphery thereof, can be decided upon as the URL data to be used in searching.

In step 166, by using a search engine provided on the internet, the CPU 60 searches for a user account of a social network that shares the URL expressed by the decided-upon URL data. In step 168, the CPU 60 stores the URL of the webpage that includes the profile of the user of the user account extracted in the search, in the similar user search result column of the search result table SRT in order in the order of the search results.

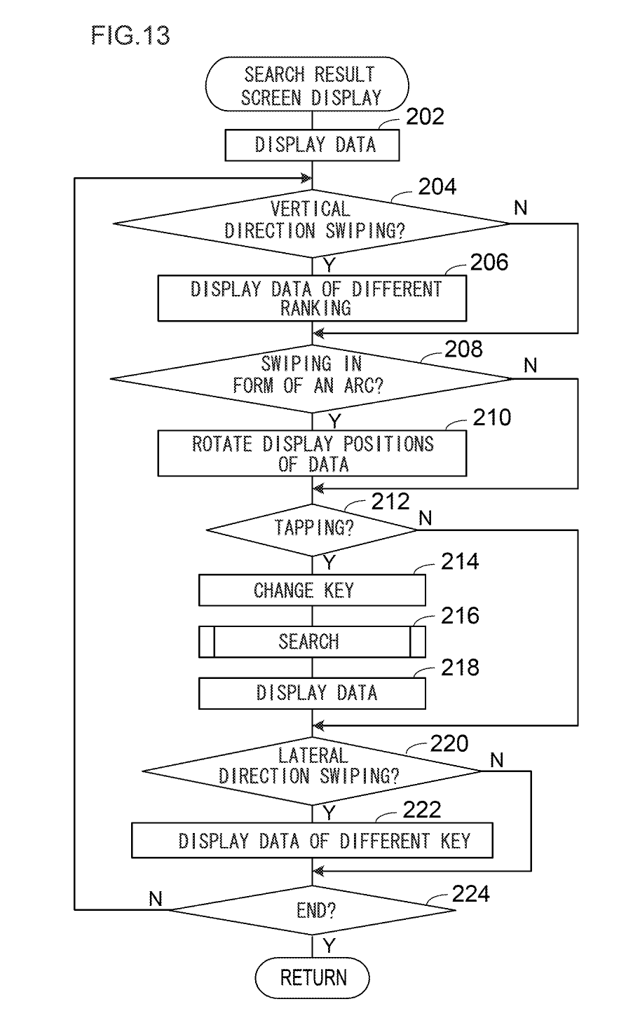

In step 108 of FIG. 6, the search result screen displaying processing illustrated in detail in FIG. 13 is carried out. In step 202 of FIG. 13, as illustrated in FIG. 7B, the CPU 60 displays a search result display screen 30B on the touch panel display 76.

The search result display screen 30B that is displayed in step 202 includes the key information display region π, the search result display region A1, the search result display region B1, the search result display region C1, and the search result display region D1.

The image, that relates to the key information that was stored in correspondence with the table number in the search result management table 26 that illustrates an example in FIG. 3, is displayed in the key information display region π. In FIG. 3, in a case in which the key information is α(1), the table number is 1.

Display data, that is included in the webpage of the URL expressed by search result a₁(1) of management number 1 that is stored in the text search result column of the search result table SRT1 (hereinafter also called display data relating to the URL), is displayed in the search result display region A1. Display data, that relates to the URL expressed by search result b₁(1) of management number 1 that is stored in the similar image search result column of the search result table SRT1, is displayed in the search result display region B1. Display data, that relates to the URL expressed by search result c₁(1) of management number 1 that is stored in the recommended search result column of the search result table SRT1, is displayed in the search result display region C1. Display data, that relates to the URL expressed by search result d₁(1) of management number 1 that is stored in the similar user search result column of the search result table SRT1, is displayed in the search result display region D1.

In step 204 of FIG. 13, the CPU 60 judges whether or not the user has swiped the touch panel display 76 in the vertical direction. In a case in which this judgment is affirmative, in step 206, the CPU 60 moves the display positions of the display data of the search result display regions. In a case in which the judgment is negative, the CPU 60 moves on to step 208.

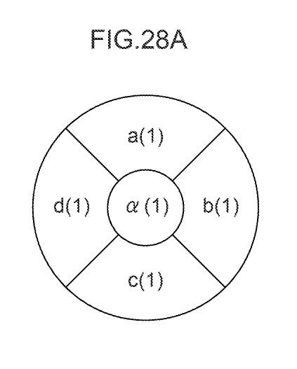

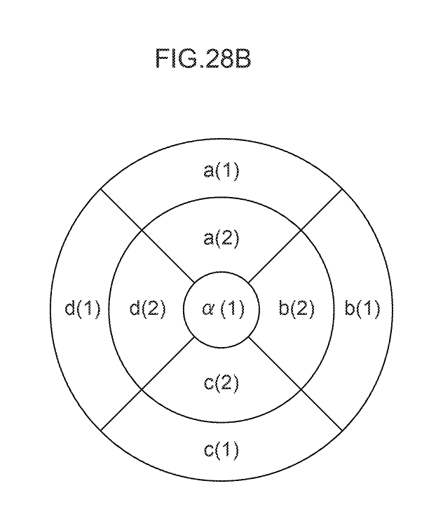

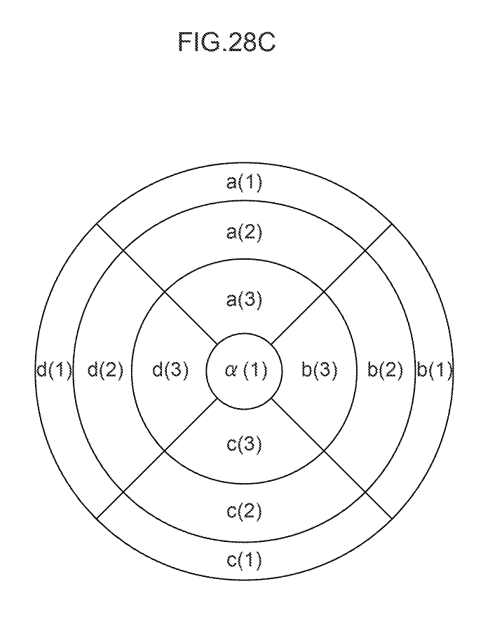

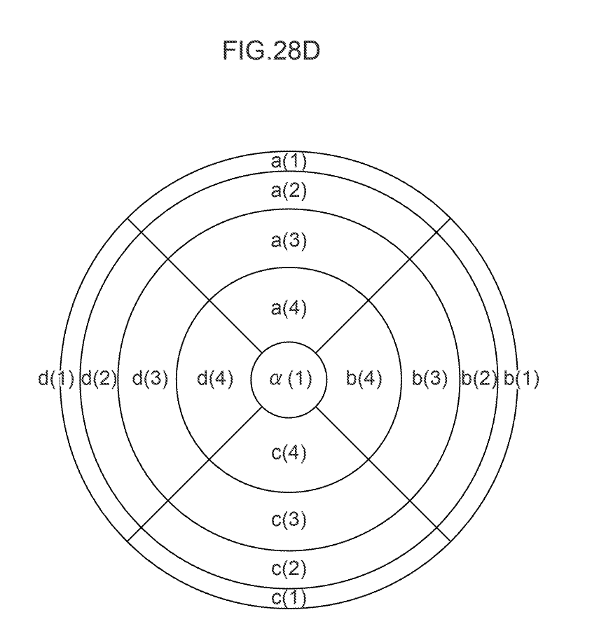

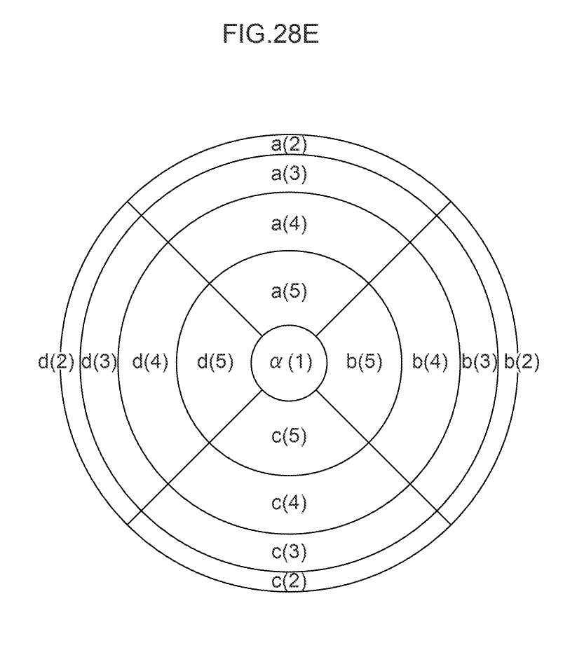

For example, as illustrated in FIG. 28A, a case in which an image relating to key information α(1) is displayed in the key information display region π in the search result display screen 30B is described. The display data, that relates to text search result a₁(1) of the search result table SRT1, is displayed in the search result display region A1. The display data, that relates to similar image search result b₁(1), is displayed in the search result display region B1. Further, the display data, that relates to recommended search result c₁(1), is displayed in the search result display region C1, and the display data, that relates to similar user search result d₁(1), is displayed in the search result display region D1. Note that, in FIG. 28A, in a case in which display data relating to search results is depicted, the display data is depicted with the subscript that indicates the table number, and the fact that this is display data relating to search results, being omitted for convenience (the same holds for description hereinafter).

Here, in a case in which, in step 204, the CPU 60 detects that the user has swiped the touch panel display 76 in the vertical direction and it is judged that the swiping is downward (the first time), the search result display regions A2, B2, C2, D2 are additionally displayed. Further, the display positions of the display data, that are displayed in the respective search result display regions, move within the sectional regions. In detail, as illustrated in FIG. 28B, the display position of the display data, that relates to the text search result a₁(1) and that was displayed in the search result display region A1, moves to the search result display region A2. Further, display data, that relates to text search result a₁(2) that has the next search result ranking after the text search result a₁(1), is displayed in the search result display region A1. Further, the display position of the display data, that relates to similar image search result b₁(1) and that is displayed in the search result display region B1, moves to the search result display region B2. Further, similar image search result b₁(2), that has the next search result ranking after the similar image search result b₁(1), is displayed in the search result display region B1. Further, the display position of the recommended search result c₁(1), that is displayed in the search result display region C1, moves to the search result display region C2, and recommended search result c₁(2), that has the next search result ranking after the recommended search result c₁(1), is displayed in the search result display region C1. Further, the display position of the display data, that relates to the similar user search result d₁(1) and that is displayed in the search result display region D1, moves to the search result display region D2. Further, similar user search result d₁(2), that has the next search result ranking after the similar user search result d₁(1), is displayed in the search result display region D1. Note that the operation of swiping downward is an example of a first touch operation.

Hereinafter, explanation is given of only the sectional region DA1. In a case in which, in step 204, the CPU 60 detects that the user has swiped the touch panel display 76 in the vertical direction and it is judged that the swiping is downward (the second time), the search result display regions A3, B3, C3, D3 are additionally displayed. As illustrated in FIG. 28C, the display position of the display data, that relates to the text search result a₁(1) and that was displayed in the search result display region A2, moves to the search result display region A3. Further, the display position of the display data, that relates to text search result a₁(2) that was displayed in the search result display region A1, moves to the search result display region A2. Further, the display data, that relates to text search result a₁(3) that has the next search result ranking after the search result a₁(2), is displayed in the search result display region A1.

Moreover, in a case in which, in step 204, the CPU 60 detects that the user has swiped the touch panel display 76 in the vertical direction and it is judged that the swiping is downward (the third time), the search result display regions A4, B4, C4, D4 are additionally displayed. As illustrated in FIG. 28D, the display position of the display data, that relates to the text search result a₁(1) and that was displayed in the search result display region A3, moves to the search result display region A4. Further, the display position of the display data, that relates to the text search result a₁(2) and that was displayed in the search result display region A2, moves to the search result display region A3. Further, the display position of the display data, that relates to the text search result a₁(3) and that was displayed in the search result display region A1, moves to the search result display region A2. Further, the display data, that relates to the text search result a₁(4) that has the next search result ranking after the search result a₁(3), is displayed in the search result display region A1.

In a case in which, in step 204, the CPU 60 detects that the user has swiped the touch panel display 76 in the vertical direction and it is judged that the swiping is downward (the fourth time), the state in which the search result display regions A1˜D4 are all displayed is maintained (the same holds for the fifth time and times thereafter as well). On the other hand, the display positions of the display data, that are displayed in the respective search result display regions, move within the sectional regions. As illustrated in FIG. 28E, the display data, that relates to the text search result a₁(1) and that was displayed in the search result display region A4, is deleted. Further, the display position of the display data, that relates to the text search result a₁(2) and that was displayed in the search result display region A3, moves to the search result display region A4. Further, the display position of the display data, that relates to the text search result a₁(3) and that was displayed in the search result display region A2, moves to the search result display region A3. Further, the display position of the display data, that relates to the text search result a₁(4) and that was displayed in the search result display region A1, moves to the search result display region A2. Further, display data, that relates to text search result a₁(5) that has the next search result ranking after the search result a₁(4), is displayed in the search result display region A1.

As described above, each time that downward swiping is detected, the display data, that were displayed in the search result display regions in the sectional regions, move in directions of moving away from the key information display region π. Further, display data, that was not displayed before the swiping was detected, is displayed in the search result display regions A1, B1, C1, D1 that are adjacent to the key information display region π.

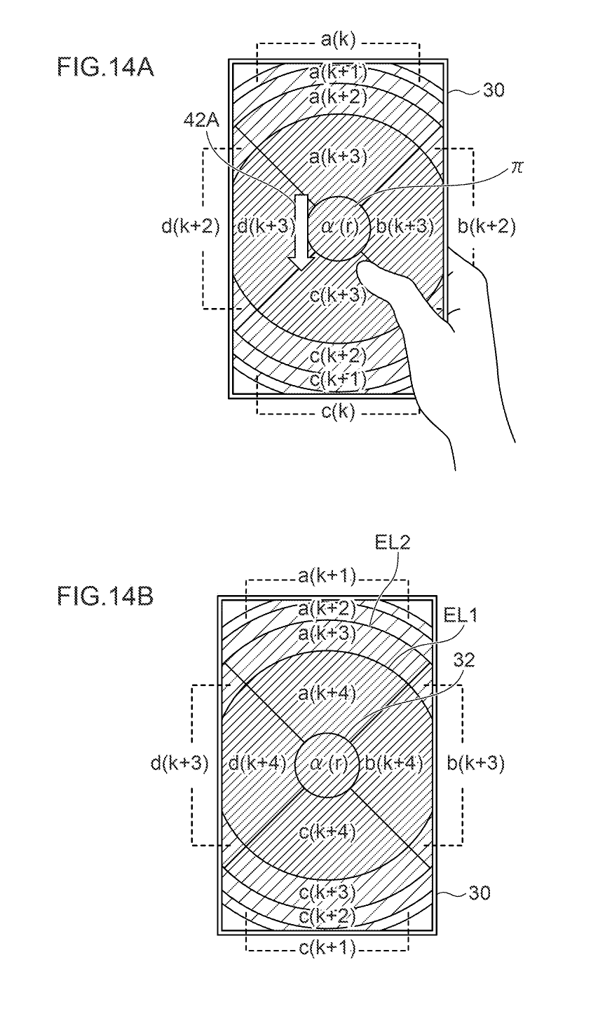

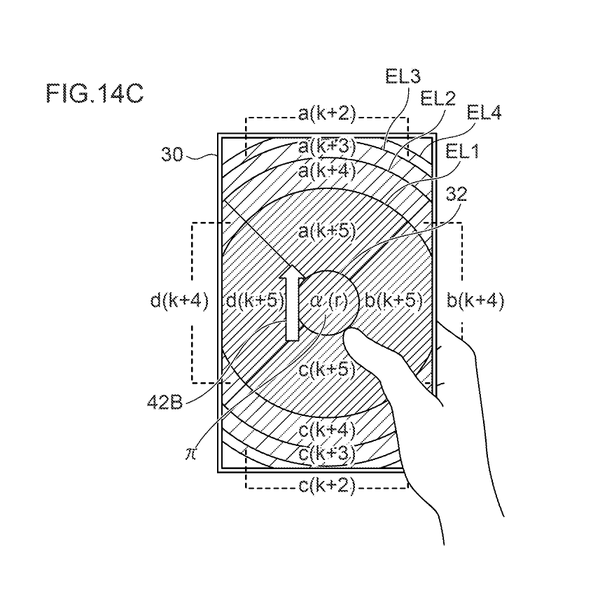

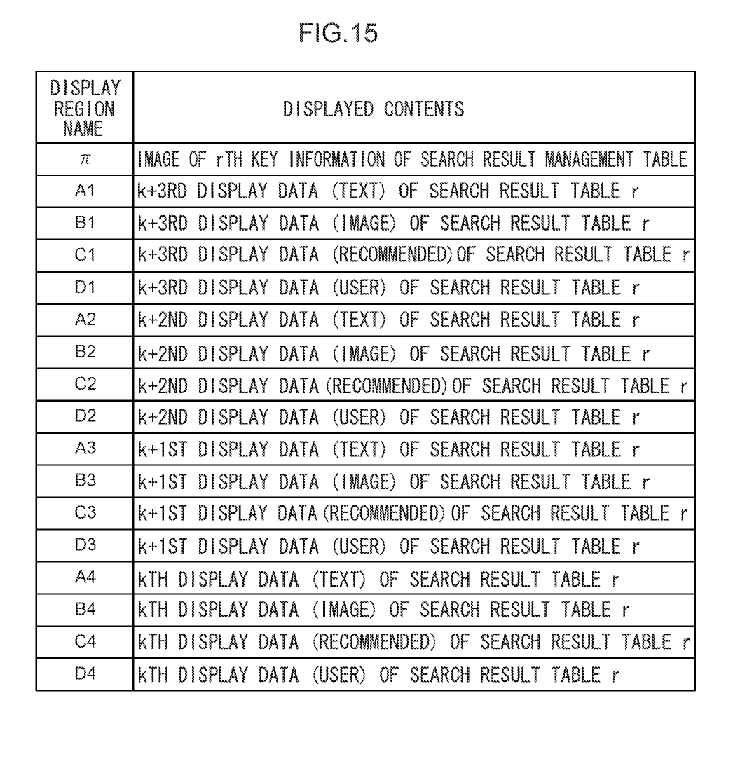

An example of the image that is displayed in the key information display region π and the display data that are displayed respectively in the search result display regions A1˜D4 (see FIG. 5), in the search result display screen 30 of FIG. 14A, is illustrated in FIG. 15. The image that relates to the key information α(r) is displayed in the key information display region π. Note that r is the table number. Here, for convenience, description is given by using the search result display screen 30 at which, after the search result display screen 30B illustrated in FIG. 7B is displayed, vertical swiping, lateral swiping, swiping in the form of an arc, and tapping, that are described later, have been carried out plural times (the same holds hereinafter).

In FIG. 14A, display data, that relate to the search results of management numbers k+3, k+2, k+1, k of the text search result column of search result table SRTr that is indicated by table number r that is stored in correspondence with key information α(r), are respectively displayed in the search result display regions A1˜A4. The URLs, that are the search results of management numbers k+3, k+2, k+1, k of the text search result column of the search result table SRTr, are expressed by aᵣ(k+3), aᵣ(k+2), aᵣ(k+1), aᵣ(k). In FIG. 14A, the display data, that relate to the URLs that are the search results of management numbers k+3, k+2, k+1, k of the text search result column of the search result table SRTr, are expressed by a(k+3), a(k+2), a(k+1), a(k), respectively. The display data, that relate to the search results of management numbers k+3, k+2, k+1, k of the similar image search result column of the search result table SRTr, are respectively displayed in the search result display regions B1˜B4. The URLs, that are the search results of management numbers k+3, k+2, k+1, k of the similar image search result column of the search result table SRTr, are expressed by bᵣ(k+3), bᵣ(k+2), bᵣ(k+1), bᵣ(k). The display data, that relate to the search results of management numbers k+3, k+2, k+1, k of the recommended search result column of the search result table SRTr, are respectively displayed in the search result display regions C1˜C4. The URLs, that are the search results of management numbers k+3, k+2, k+1, k of the recommended search result column of the search result table SRTr, are expressed by cᵣ(k+3), cᵣ(k+2), cᵣ(k+1), cᵣ(k). The display data, that relate to the search results of management numbers k+3, k+2, k+1, k of the similar user search result column of the search result table SRTr, are respectively displayed in the search result display regions D1˜D4. The URLs, that are the search results of management numbers k+3, k+2, k+1, k of the similar user search result column of the search result table SRTr, are expressed by dᵣ(k+3), dᵣ(k+2), dᵣ(k+1), dᵣ(k). In the case in which r=1 and k=1, display data, that relates to the text search result a₁(4) of management number 4 of the search result table SRT1, is displayed in the search result display region A1 in which display data relating to the text search result aᵣ(k+3) is displayed.

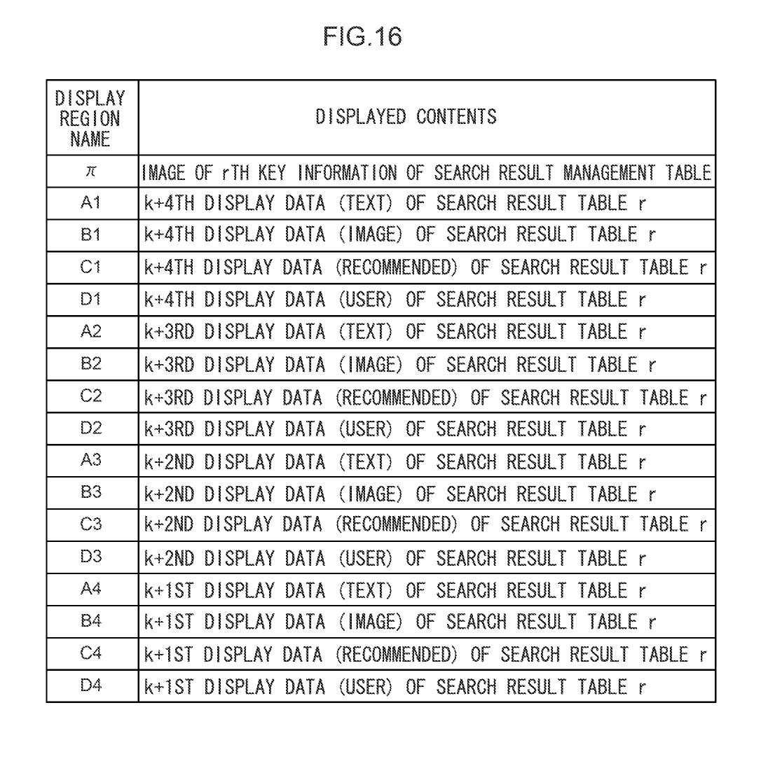

In step 204 of FIG. 13, in a case in which the CPU 60 detects that the user has swiped the touch panel display 76 in the vertical direction and it is judged that the swiping is downward as indicated by arrow 42A in FIG. 14A, in step 206, the display positions of the display data move. An example of the search result display screen 30 after swiping is carried out is illustrated in FIG. 14B. Examples of the display data, that are displayed in the key information display region π and the search result display regions A1˜D4 respectively in the search result display screen 30 of FIG. 14B, are illustrated in FIG. 16.

The image relating to the key information α(r) is displayed in the key information display region π. Namely, the display of the key information display region π is not changed. The display data, that relate to the search results of management numbers k+4, k+3, k+2, k+1 of the text search result column of the search result table SRTr, are respectively displayed in the search result display regions A1˜A4. The URLs, that are the search results of management numbers k+4, k+3, k+2, k+1 of the text search result column of the search result table SRTr, are expressed by aᵣ(k+4), aᵣ(k+3), aᵣ(k+2), aᵣ(k+1). The display data, that relate to the search results of management numbers k+4, k+3, k+2, k+1 of the similar image search result column of the search result table SRTr, are respectively displayed in the search result display regions B1˜B4. The URLs, that are the search results of management numbers k+4, k+3, k+2, k+1 of the similar image search result column of the search result table SRTr, are expressed by bᵣ(k+4), bᵣ(k+3), bᵣ(k+2), bᵣ(k+1). The display data, that relate to the search results of management numbers k+4, k+3, k+2, k+1 of the recommended search result column of the search result table SRTr, are respectively displayed in the search result display regions C1˜C4. The URLs, that are the search results of management numbers k+4, k+3, k+2, k+1 of the recommended search result column of the search result table SRTr, are expressed by cᵣ(k+4), cᵣ(k+3), cᵣ(k+2), cᵣ(k+1). The display data, that relate to the search results of management numbers k+4, k+3, k+2, k+1 of the similar user search result column of the search result table SRTr, are respectively displayed in the search result display regions D1˜D4. The URLs, that are the search results of management numbers k+4, k+3, k+2, k+1 of the similar user search result column of the search result table SRTr, are expressed by dᵣ(k+4), dᵣ(k+3), dᵣ(k+2), dᵣ(k+1).

For example, the four search result display regions A1˜A4 of the sectional region DA1 are described in detail. In FIG. 14A, the four search results of management numbers k+3˜k of the text search result column are extracted from the search result table r. Further, display data, that relate to the four search results of management numbers k+3˜k of the text search result column, are displayed in the search result display regions A1˜A4, respectively. In FIG. 14B, the search results of management numbers k+4˜k+1, that have been shifted by one toward the side of the larger management numbers in the text search result column, are extracted from the search result table r. Further, the display data, that relate to the search results of management numbers k+4˜k+1 of the text search result column, are displayed in the search result display regions A1, A2, A3, A4, respectively. The same holds as well for the sectional regions DA2˜DA4.

Namely, the display positions of the display data, that were displayed in the search result display regions A1, B1, C1, D1, are respectively moved to the search result display regions A2, B2, C2, D2. Further, the display positions of the display data, that were displayed in the search result display regions A2, B2, C2, D2, are respectively moved to the search result display regions A3, B3, C3, D3. Further, the display positions of the display data, that were displayed in the search result display regions A3, B3, C3, D3, are respectively moved to the search result display regions A4, B4, C4, D4. Further, the display data, that were displayed in the search result display regions A4, B4, C4, D4, are deleted. Further, the display data, that relate to search results whose management number is one greater than the search results related to the display data that were displayed in the search result display regions A1, B1, C1, D1, are displayed in the search result display regions A1, B1, C1, D1. Due thereto, the user is given the impression as if the display data are pouring-out from the key information display region π.

In FIG. 14C, the image relating to the key information α(r) is displayed in the key information display region π. The display data, that relate to the search results of management numbers k+5, k+4, k+3, k+2 of the text search result column of the search result table SRTr, are respectively displayed in the search result display regions A1˜A4. The URLs, that are the search results of management numbers k+5, k+4, k+3, k+2 of the text search result column of the search result table SRTr, are expressed by aᵣ(k+5), aᵣ(k+4), aᵣ(k+3), aᵣ(k+2). The display data, that relate to the search results of management numbers k+5, k+4, k+3, k+2 of the similar image search result column of the search result table SRTr, are respectively displayed in the search result display regions B1˜B4. The URLs, that are the search results of management numbers k+5, k+4, k+3, k+2 of the similar image search result column of the search result table SRTr, are expressed by bᵣ(k+5), bᵣ(k+4), bᵣ(k+3), bᵣ(k+2). The display data, that relate to the search results of management numbers k+5, k+4, k+3, k+2 of the recommended search result column of the search result table SRTr, are respectively displayed in the search result display regions C1˜C4. The URLs, that are the search results of management numbers k+5, k+4, k+3, k+2 of the recommended search result column of the search result table SRTr, are expressed by cᵣ(k+5), cᵣ(k+4), cᵣ(k+3), cᵣ(k+2). The display data, that relate to the search results of management numbers k+5, k+4, k+3, k+2 of the similar user search result column of the search result table SRTr, are respectively displayed in the search result display regions D1˜D4. The URLs, that are the search results of management numbers k+5, k+4, k+3, k+2 of the similar user search result column of the search result table SRTr, are expressed by dᵣ(k+5), dᵣ(k+4), dᵣ(k+3), dᵣ(k+2).

In step 204 of FIG. 13, in a case in which the CPU 60 detects that the user has swiped the touch panel display 76 in the vertical direction and it is judged that the swiping is upward as indicated by arrow 42B in FIG. 14C, in step 206, the display positions of the display data are moved. An example of the search result display screen 30 after the display positions of the display data are moved is illustrated in FIG. 14B. Because the search result display screen 30 of FIG. 14B was described above, details thereof are omitted. Note that the operation of swiping upward is an example of a second touch operation.

For example, the four search result display regions A1˜A4 of the sectional region DA1 are described in detail. In FIG. 14C, the four search results of management numbers k+5˜k+2 of the text search result column are extracted from the search result table r. Further, display data, that relate to the four search results of management numbers k+5˜k+2 of the text search result column, are displayed in the search result display regions A1˜A4, respectively. In FIG. 14B, the search results of management numbers k+4˜k+1, that have been shifted by one toward the side of the smaller management numbers in the text search result column, are extracted from the search result table r. Further, images, that relate to the search results of management numbers k+4˜k+1 of the text search result column, are displayed in the search result display regions A1, A2, A3, A4, respectively. The direction of the shifting is the direction opposite the shifting in the case in which downward swiping was detected. Further, the same holds as well for the sectional regions DA2˜DA4.

Namely, the display data, that relate to search results whose management number is one smaller than the search results related to the display data that were displayed in the search result display regions A4, B4, C4, D4, are displayed in the search result display regions A4, B4, C4, D4. The display positions of the display data, that were displayed in the search result display regions A4, B4, C4, D4, are respectively moved to the search result display regions A3, B3, C3, D3. Further, the display positions of the display data, that were displayed in the search result display regions A3, B3, C3, D3, are respectively moved to the search result display regions A2, B2, C2, D2. Further, the display positions of the display data, that were displayed in the search result display regions A2, B2, C2, D2, are respectively moved to the search result display regions A1, B1, C1, D1. Further, the display data, that were displayed in the search result display regions A1, B1, C1, D1, are deleted. Due thereto, the user is given the impression as if the display data are being pulled-into the key information display region π.

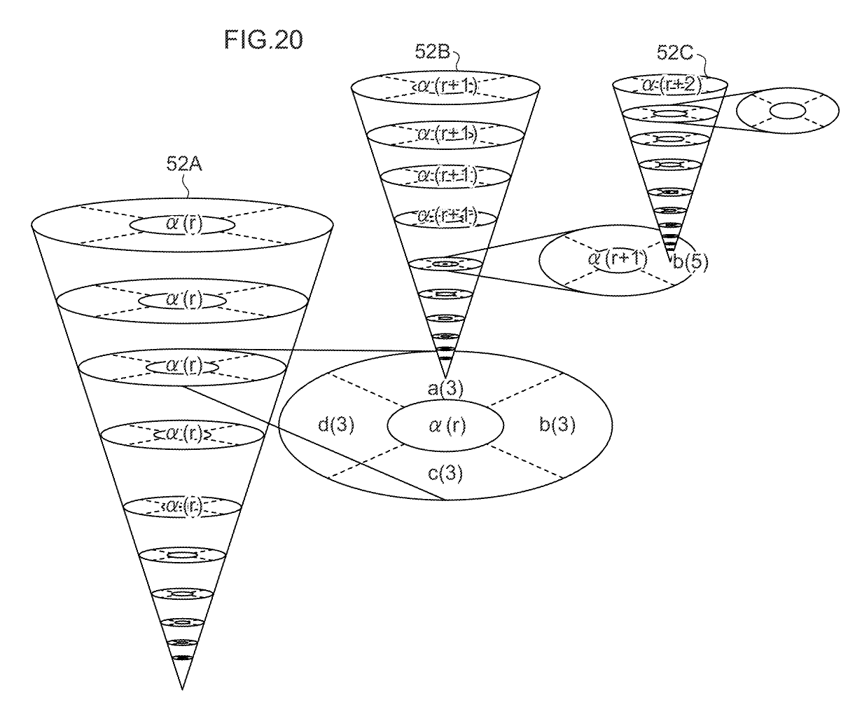

In this way, accompanying the user swiping in the vertical direction, the display positions of the display data are changed such that the user is given the impression that the display data are pouring-out from the key information display region π, or that the display data are being pulled-into the key information display region π. Due thereto, the key information and the four search results, that are displayed adjacent to the key information among the plural search results that were retrieved on the basis of the key information, can be displayed so as to be able to be grasped collectively in a short time. Further, the user can experience a sense of depth as if advancing or retreating in a tunnel, at a search result display screen that is displayed on a two-dimensional display (see FIG. 20).

Further, an image is displayed in the key information display region as the information relating to the key information, and images are displayed in the respective search result display regions as information relating to the search results. Due thereto, the user can intuitively recognize the search results.

In step 208 of FIG. 13, the CPU 60 judges whether or not the user has swiped the touch panel display 76 in the form of an arc. In a case in which the judgment is affirmative, in step 210, the CPU 60 rotatingly moves the display positions of the data of the search result display regions. In a case in which the judgment is negative, the CPU 60 moves on to step 212.

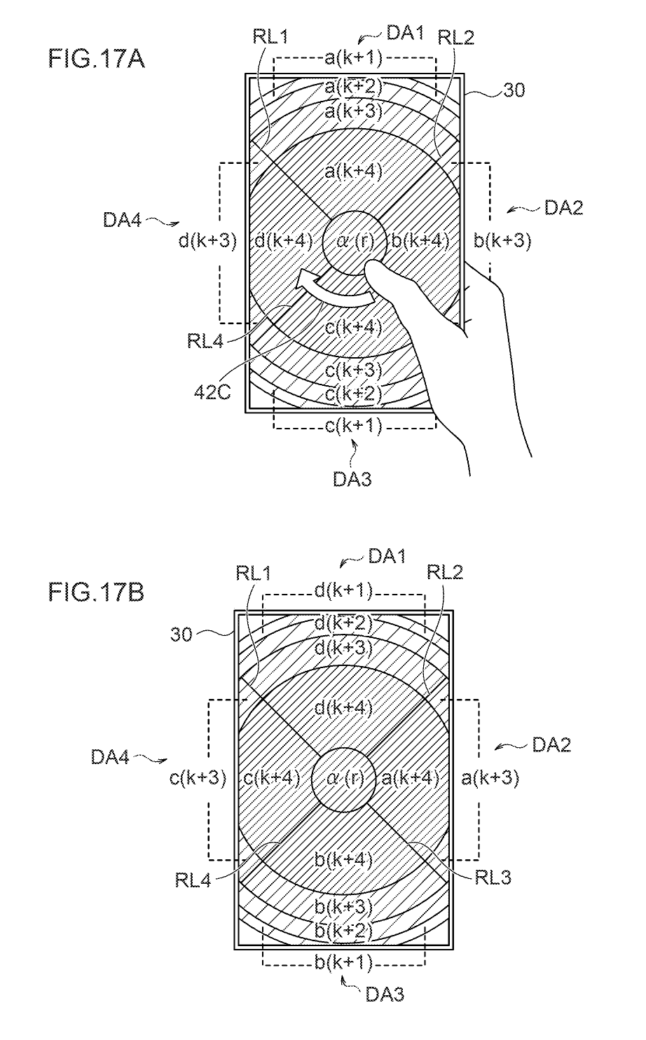

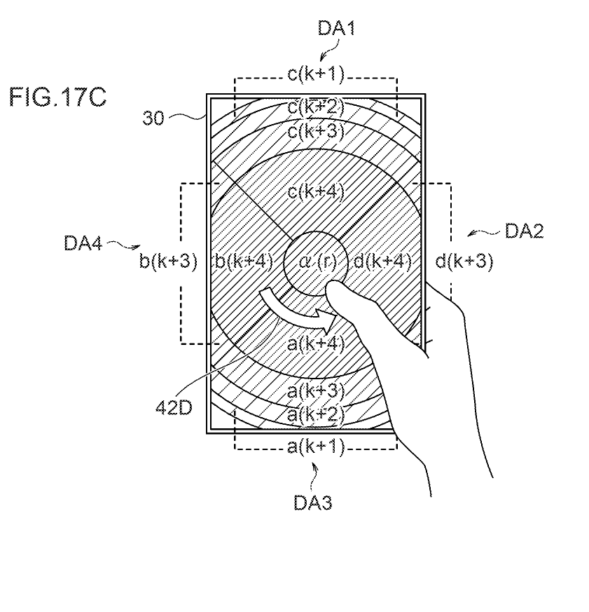

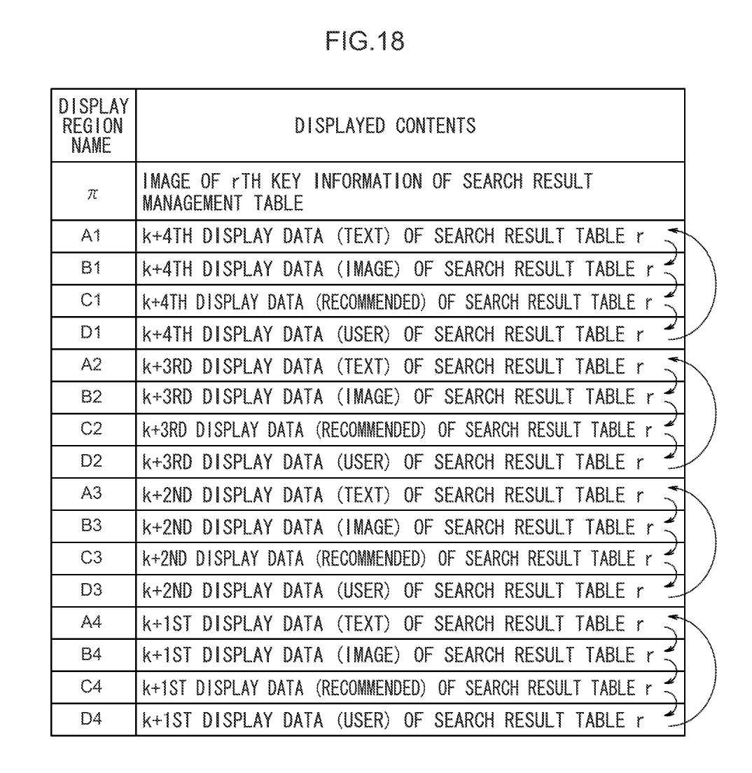

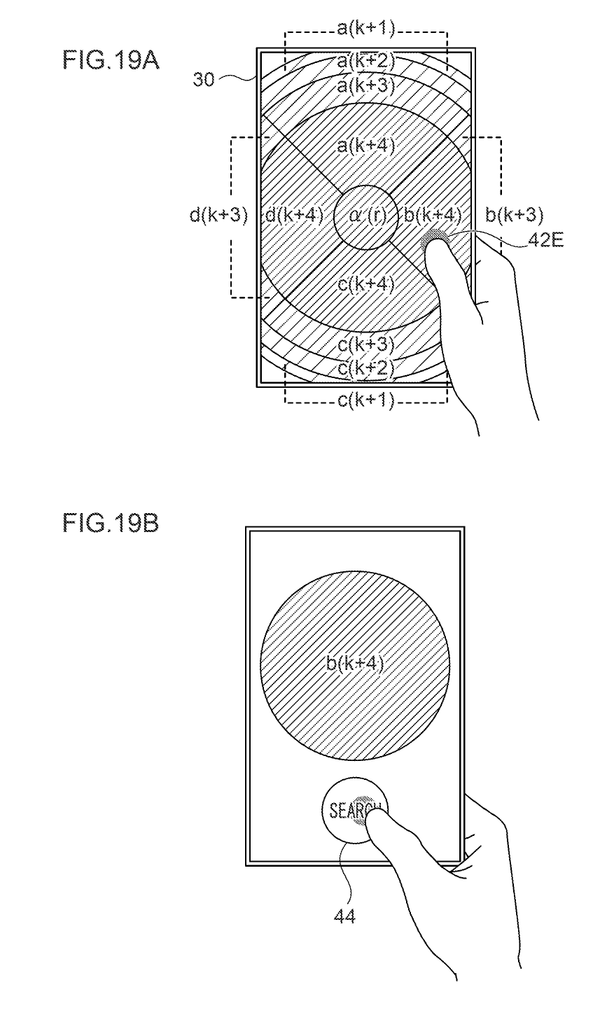

FIG. 18 illustrates the image that relates to the key information and that is displayed in the key information display region it, and the display data that are displayed in the search result display regions A1˜D4, of the search result display screen 30 of FIG. 17A. Because the search result display screen 30 of FIG. 17A is similar to the search result display screen 30 of FIG. 14B, details thereof are omitted.

In step 208, in a case in which the CPU 60 detects that the user has swiped the touch panel display 76 in the form of an arc, and the direction of the swiping is clockwise as indicated by arrow 42C in FIG. 17A, in step 210, the CPU 60 moves the display positions of the display data. The search result display screen 30 in a case in which clockwise swiping has been detected is illustrated in FIG. 17B. As illustrated in the example in FIG. 17B and FIG. 18, the image relating to the key information α(r) is displayed in the key information display region π. Namely, the display of the key information display region π is not changed. As indicated by the arrows at the right end of the table of FIG. 18, the display data, that relate to the search results of management numbers k+4, k+3, k+2, k+1 of the similar user search result column of the search result table SRTr, are respectively displayed in the search result display regions A1˜A4. The URLs, that are the search results of management numbers k+4, k+3, k+2, k+1 of the similar user search result column of the search result table SRTr, are expressed by dᵣ(k+4), dᵣ(k+3), dᵣ(k+2), dᵣ(k+1). The display data, that relate to the search results of management numbers k+4, k+3, k+2, k+1 of the text search result column of the search result table SRTr, are respectively displayed in the search result display regions B1˜B4. The URLs, that are the search results of management numbers k+4, k+3, k+2, k+1 of the text search result column of the search result table SRTr, are expressed by aᵣ(k+4), aᵣ(k+3), aᵣ(k+2), aᵣ(k+1). The display data, that relate to the search results of management numbers k+4, k+3, k+2, k+1 of the similar image search result column of the search result table SRTr, are respectively displayed in the search result display regions C1˜C4. The URLs, that are the search results of management numbers k+4, k+3, k+2, k+1 of the similar image search result column of the search result table SRTr, are expressed by bᵣ(k+4), bᵣ(k+3), bᵣ(k+2), bᵣ(k+1). The display data, that relate to the search results of management numbers k+4, k+3, k+2, k+1 of the recommended search result column of the search result table SRTr, are respectively displayed in the search result display regions D1˜D4. The URLs, that are the search results of management numbers k+4, k+3, k+2, k+1 of the recommended search result column of the search result table SRTr, are expressed by cᵣ(k+4), cᵣ(k+3), cᵣ(k+2), cᵣ(k+1). Note that the operation of swiping clockwise is an example of a third touch operation.

Namely, the display positions of the display data, that were displayed in the search result display regions A1˜A4 of the sectional region DA1, are moved to the search result display regions B1˜B4 of the sectional region DA2, respectively. Further, the display positions of the display data, that were displayed in the search result display regions B1˜B4 of the sectional region DA2, are moved to the search result display regions C1˜C4 of the sectional region DA3, respectively. Further, the display positions of the display data, that were displayed in the search result display regions C1˜C4 of the sectional region DA3, are moved to the search result display regions D1˜D4 of the sectional region DA4, respectively. The display positions of the display data, that were displayed in the search result display regions D1˜D4 of the sectional region DA4, are moved to the search result display regions A1˜A4 of the sectional region DA1, respectively. Namely, the respective display positions of information relating to the search results, that were displayed in the respective sectional regions, are respectively moved to the search result display regions of the sectional region that exists in the advancing direction of the clockwise direction. Due thereto, the user is given the impression as if the display data, that are displayed in the search result display regions, are rotating clockwise.

In the search result display screen 30 that illustrates an example in FIG. 17C, the image relating to the key information α(r) is displayed in the key information display region π. The display data, that relate to the search results of management numbers k+4, k+3, k+3, k+1 of the recommended search result column of the search result table SRTr, are respectively displayed in the search result display regions A1˜A4. The URLs, that are the search results of management numbers k+4, k+3, k+2, k+1 of the recommended search result column of the search result table SRTr, are expressed by cᵣ(k+4), cᵣ(k+3), cᵣ(k+2), cᵣ(k+1). The display data, that relate to the search results of management numbers k+4, k+3, k+2, k+1 of the similar user search result column of the search result table SRTr, are respectively displayed in the search result display regions B1˜B4. The URLs, that are the search results of management numbers k+4, k+3, k+2, k+1 of the similar user search result column of the search result table SRTr, are expressed by dᵣ(k+4), dᵣ(k+3), dᵣ(k+2), dᵣ(k+1). The display data, that relate to the search results of management numbers k+4, k+3, k+2, k+1 of the text search result column of the search result table SRTr, are respectively displayed in the search result display regions C1˜C4. The URLs, that are the search results of management numbers k+4, k+3, k+2, k+1 of the text search result column of the search result table SRTr, are expressed by aᵣ(k+4), aᵣ(k+3), aᵣ(k+2), aᵣ(k+1). The display data, that relate to the search results of management numbers k+4, k+3, k+2, k+1 of the similar image search result column of the search result table SRTr, are respectively displayed in the search result display regions D1˜D4. The URLs, that are the search results of management numbers k+4, k+3, k+2, k+1 of the similar image search result column of the search result table SRTr, are expressed by bᵣ(k+4), bᵣ(k+3), bᵣ(k+2), bᵣ(k+1).

In step 208, in a case in which the CPU 60 detects that the user has swiped the touch panel display 76 in the form of an arc, and the direction of the swiping is counterclockwise as indicated by arrow 42D in FIG. 17C, in step 210, the CPU 60 moves the display positions of the display data. The search result display screen 30 in a case in which counterclockwise swiping has been detected is illustrated in FIG. 17B. Because the search result display screen 30 of FIG. 17B has been described above, details thereof are omitted. Note that the operation of swiping counterclockwise is an example of a fourth touch operation.

Namely, the display positions of the display data, that were displayed in the search result display regions A1˜A4 of the sectional region DA1, are moved to the search result display regions D1˜D4 of the sectional region DA4, respectively. Further, the display positions of the display data, that were displayed in the search result display regions D1˜D4 of the sectional region DA4, are moved to the search result display regions C1˜C4 of the sectional region DA3, respectively. Further, the display positions of the display data, that were displayed in the search result display regions C1˜C4 of the sectional region DA3, are moved to the search result display regions B1˜B4 of the sectional region DA2, respectively. The display positions of the display data, that were displayed in the search result display regions B1˜B4 of the sectional region DA2, are moved to the search result display regions A1˜A4 of the sectional region DA1, respectively. Namely, the respective display positions of information relating to the search results, that were displayed in the respective sectional regions, are respectively moved to the search result display regions of the sectional region that exists in the advancing direction of the counterclockwise direction. Due thereto, the user is given the impression as if the display data, that are displayed in the search result display regions, are rotating counterclockwise.

In this way, accompanying the swiping in the form of an arc by a user, the display positions of the display data move as if rotating like a roulette wheel clockwise or counterclockwise. Due thereto, in a case in which the user is operating the smart device with one hand, the user can rotatingly move the display positions of the display data to positions where operation is easy. Further, the user can rotatingly move the display positions of the display data to positions that are easy to see.

In step 212, the CPU 60 judges whether or not the user has tapped on the touch panel display 76. In a case in which the judgment is affirmative, in step 214, the CPU 60 changes the key information, and, in step 216, the CPU 60 carries out searching by using the changed key information. In step 218, the CPU 60 displays the search results in the search result display regions. In a case in which the judgment in step 212 is negative, the CPU 60 moves on to step 220.

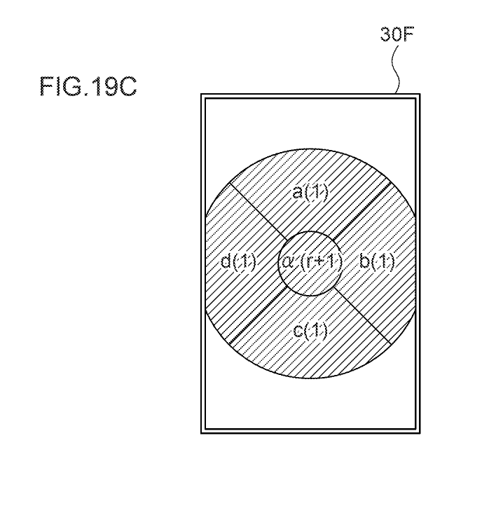

An example of the search result display screen 30 is illustrated in FIG. 19A. Because the search result display screen 30 of FIG. 19A is similar to the search result display screen 30 of FIG. 14B, details thereof are omitted.

In step 212, as illustrated in FIG. 19A, in a case in which the CPU 60 detects that the user has tapped on the position indicated by circle 42E on the touch panel display 76, the CPU 60 displays a webpage as illustrated in FIG. 19B. In detail, the CPU 60 displays the webpage that is indicated by bᵣ(k+4) that is the URL that is related to the display data b(k+4) that was displayed in the search result display region that is at the position that was tapped. Further, the CPU 60 displays a search button 44 beneath the display of the webpage. When the CPU 60 detects that the user has tapped on the search button 44 as illustrated in FIG. 19B, in step 214, the CPU 60 sets, as key information, bᵣ(k+4) that is the URL of the webpage displayed in FIG. 19B. In a case in which the largest table number of the search result management table 26 illustrated in FIG. 3 is r, r+1 that is the value obtained by adding 1 to r is made to be the table number, and the URL of the webpage displayed in FIG. 19B is stored as key information in correspondence with this table number. In step 216, the CPU 60 carries out the searching processing that is illustrated in detail in FIG. 8. Because this searching processing was described above, description thereof is omitted. A search result table SRTr+1 is generated, and the search results of the search carried out in step 216 are stored in the generated search result table. In step 218, the CPU 60 displays search result display screen 30F as illustrated in FIG. 19C. r is the order number of the search before tapping (the order number of the search history) (see FIG. 19A), and r+1 expresses the order number of the search after tapping and searching (FIG. 19C). A case in which r=1 indicates that this is the search that is carried out initially. Note that 0 may be made to be the order number of the search that is carried out initially. Note that tapping is an example of a fifth touch operation.

The search result display screen 30F includes the key information display region π and the search result display regions A1, B1, C1, D1. An image relating to the key information α(r+1), i.e., bᵣ(k+4), is displayed in the key information display region π.

Display data, that relates to the URL expressed by aᵣ₊₁(1) of management number 1 that is stored in the text search result column of the search result table SRTr+1, is displayed in the search result display region A1. Display data, that relates to the URL expressed by bᵣ₊₁(1) of management number 1 that is stored in the similar image search result column of the search result table SRTr+1, is displayed in the search result display region B1. Display data, that relates to the URL expressed by cᵣ₊₁(1) of management number 1 that is stored in the recommended search result column of the search result table SRTr+1, is displayed in the search result display region C1. Display data, that relates to the URL expressed by dᵣ₊₁(1) of management number 1 that is stored in the similar user search result column of the search result table SRTr+1, is displayed in the search result display region D1.

In detail, when the search result display image A1, in which is displayed the image of shoes illustrated in FIG. 7C, is tapped, the image of the shoes is displayed in an enlarged manner as illustrated in FIG. 7D. Moreover, when a select button 46, that is displayed beneath the image of the shoes that is displayed in an enlarged manner, is tapped, the webpage, from which the image of the shoes was extracted, is displayed as illustrated in FIG. 7E. When the search button 44 that is displayed beneath the image of the webpage is tapped, the URL of the webpage that is displayed is set as key information, and a search is carried out in accordance with the key extracted from the webpage that is displayed. Further, as illustrated in FIG. 7F, the search result display screen 30F in accordance with this search is displayed. The shoes are displayed as the image relating to the key information, in the key information display region π of the search result display screen 30F.

The linking of the above-described searches is explained in the schematic drawing illustrated in FIG. 20. Cone 52A schematically depicts the search results of the search carried out by using α(r) as the key information. When the search result display region that displays display data a(3) that relates to a text search result is tapped, text search result aᵣ(3) is set as key information α(r+1) and searching is carried out. Cone 52B schematically depicts the search results of the search carried out by using α(r+1) as the key information. When the search result display region that displays display data b(5) that relates to a similar image search result is tapped, bᵣ₊₁(5) is set as key information α(r+2) and searching is carried out. Cone 52C schematically depicts the search results of the search carried out by using α(r+2) as the key information.

In this way, in accordance with tapping of the user, searches whose key information are changed are carried out, and the search results are provided to the user. Due thereto, the user can rapidly browse a large amount of display data relating to search results, without putting the search key into words or refining the search key. Further, due thereto, the user can enjoy searching freely as if skipping from provided information to provided information, and can experience the joy of discovery.

In step 220, the CPU 60 judges whether or not the user has swiped the touch panel display 76 in the lateral direction. In a case in which the judgment is affirmative, in step 222, the CPU 60 displays, in the search result display regions, the search results that were retrieved by using a key extracted from a webpage expressed by a URL that is different key information. In a case in which the judgment is negative, the CPU 60 moves on to step 224.

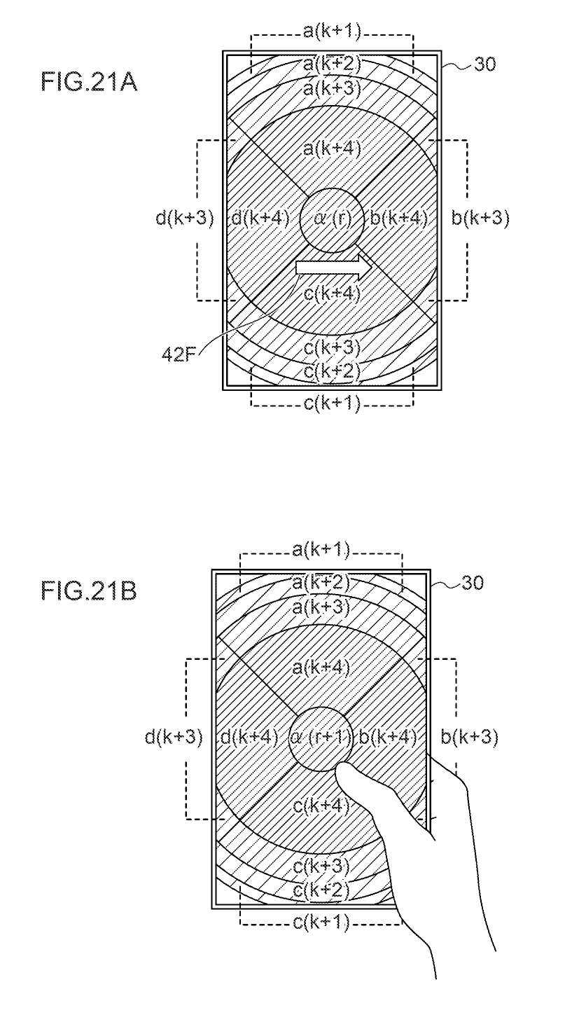

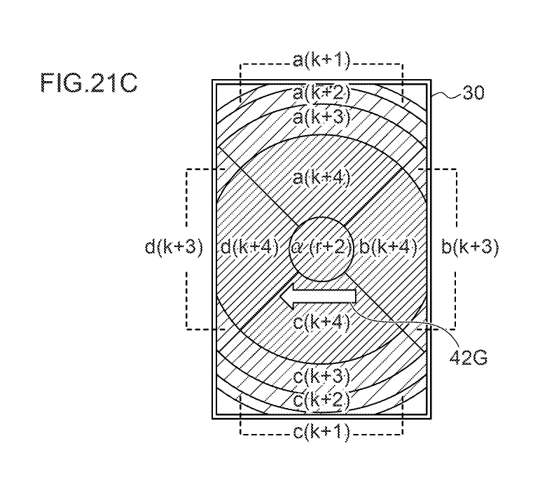

Because the search result display screen 30 that illustrates an example in FIG. 21A is similar to FIG. 14B, details thereof are omitted.

In step 220, in a case in which the CPU 60 detects that the user has swiped the touch panel display 76 in the lateral direction, and it is judged that the swiping is rightward as indicated by arrow 42F in FIG. 21A, in step 222, the CPU 60 changes the display. The operation of swiping toward the right is, for example, the operation of transitioning, by one, to search r+1 that is carried out immediately after search r. Note that the operation of rightward swiping is an example of a sixth touch operation.

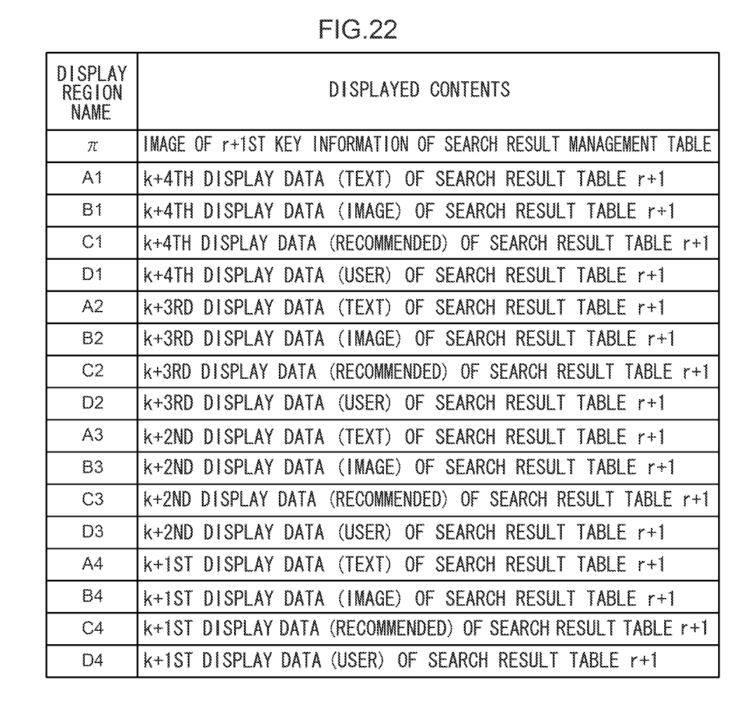

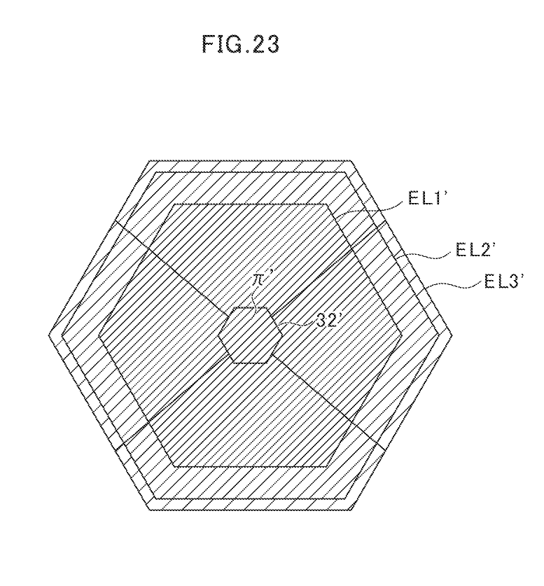

As illustrated in FIG. 22, the image relating to the key information α(r+1) is displayed in the key information display region π in FIG. 21B. The display data, that relate to the search results of management numbers k+4, k+3, k+3, k+1 of the text search result column of the search result table SRTr+1, are respectively displayed in the search result display regions A1˜A4. The URLs, that are the search results of management numbers k+4, k+3, k+2, k+1 of the text search result column of the search result table SRTr+1, are expressed by aᵣ₊₁(k+4), aᵣ₊₁(k+3), aᵣ₊₁(k+2), aᵣ₊₁(k+1). The display data, that relate to the search results of management numbers k+4, k+3, k+2, k+1 of the similar image search result column of the search result table SRTr+1, are respectively displayed in the search result display regions B1˜B4. The URLs, that are the search results of management numbers k+4, k+3, k+2, k+1 of the similar image search result column of the search result table SRTr+1, are expressed by bᵣ₊₁(k+4), bᵣ₊₁(k+3), bᵣ₊₁(k+2), bᵣ₊₁(k+1). The display data, that relate to the search results of management numbers k+4, k+3, k+2, k+1 of the recommended search result column of the search result table SRTr+1, are respectively displayed in the search result display regions C1˜C4. The URLs, that are the search results of management numbers k+4, k+3, k+2, k+1 of the recommended search result column of the search result table SRTr+1, are expressed by cᵣ₊₁(k+4), cᵣ₊₁(k+3), cᵣ₊₁(k+2), cᵣ₊₁(k+1). The display data, that relate to the search results of management numbers k+4, k+3, k+2, k+1 of the similar user search result column of the search result table SRTr+1, are respectively displayed in the search result display regions D1˜D4. The URLs, that are the search results of management numbers k+4, k+3, k+2, k+1 of the similar user search result column of the search result table SRTr+1, are expressed by dᵣ₊₁(k+4), dᵣ₊₁(k+3), dᵣ₊₁(k+2), dᵣ₊₁(k+1).

In detail, in FIG. 21A, display data, that relate to search results in accordance with the key extracted from the webpage that is indicated by the URL expressed by the key information α(r), are displayed. As illustrated in FIG. 21A, when swiping toward the right is detected, in FIG. 21B, search results in accordance with the key extracted from the webpage that is indicated by the URL expressed by the key information α(r+1) are displayed.

In FIG. 21C, an image relating to the key information α(r+2) is displayed in the key information display region π. The display data, that relate to the search results of management numbers k+4, k+3, k+3, k+1 of the text search result column of the search result table SRTr+2, are respectively displayed in the search result display regions A1˜A4. The URLs, that are the search results of management numbers k+4, k+3, k+2, k+1 of the text search result column of the search result table SRTr+2, are expressed by aᵣ₊₂(k+4), aᵣ₊₂(k+3), aᵣ₊₂(k+2), aᵣ₊₂(k+1). The display data, that relate to the search results of management numbers k+4, k+3, k+2, k+1 of the similar image search result column of the search result table SRTr+2, are respectively displayed in the search result display regions B1˜B4. The URLs, that are the search results of management numbers k+4, k+3, k+2, k+1 of the similar image search result column of the search result table SRTr+2, are expressed by bᵣ₊₂(k+4), bᵣ₊₂(k+3), bᵣ₊₂(k+2), bᵣ₊₂(k+1). The display data, that relate to the search results of management numbers k+4, k+3, k+2, k+1 of the recommended search result column of the search result table SRTr+2, are respectively displayed in the search result display regions C1˜C4. The URLs, that are the search results of management numbers k+4, k+3, k+2, k+1 of the recommended search result column of the search result table SRTr+2, are expressed by cᵣ₊₂(k+4), cᵣ₊₂(k+3), cᵣ₊₂(k+2), cᵣ₊₂(k+1). The display data, that relate to the search results of management numbers k+4, k+3, k+2, k+1 of the similar user search result column of the search result table SRTr+2, are respectively displayed in the search result display regions D1˜D4. The URLs, that are the search results of management numbers k+4, k+3, k+2, k+1 of the similar user search result column of the search result table SRTr+2, are expressed by dᵣ₊₂(k+4), dᵣ₊₂(k+3), dᵣ₊₂(k+2), dᵣ₊₂(k+1).

In step 220, in a case in which the CPU 60 detects that the user has swiped the touch panel display 76 in the lateral direction, and it is judged that the swiping is leftward as indicated by arrow 42G in FIG. 21C, in step 222, the CPU 60 changes the display. The operation of swiping toward the left is, for example, the operation of transitioning, by one, to search r+1 that was carried out immediately before search r+2. Note that the operation of leftward swiping is an example of a seventh touch operation.

Because the search result display screen 30 of FIG. 21B was described above, details thereof are omitted.

In detail, in FIG. 21C, search results in accordance with the key extracted from the webpage that is indicated by the URL expressed by the key information α(r+2) are displayed. Further, as illustrated in FIG. 21B, when swiping toward the left is detected, search results in accordance with the key extracted from the webpage that is indicated by the URL expressed by the key information α(r+1) are displayed.

In this way, in accordance with the swiping in the lateral direction by the user, the key information is changed, and search results in accordance with a key extracted from a webpage that is indicated by a URL expressed by different key information are displayed. Due thereto, the user can easily browse the history of search results of searches carried out on the basis of different key information.

In step 224, it is judged whether or not an unillustrated end button, that is displayed on the touch panel display 76, has been tapped by the user. When this judgment is affirmative, the CPU 60 ends the search result displaying processing. When this judgment is negative, the CPU 60 returns to step 202.

Note that the above describes an example in which, each time the user carries out a swiping operation one time, the display data moves by one search result display region each time. However, the technique of the disclosure is not limited to this. For example, the display may be moved by an amount corresponding to plural search result display regions, in accordance with the length of the swipe. Further, when a swiping operation is carried out, moving of the display positions of the display data may be started, and thereafter, when another operation such as a touch operation or the like is carried out, the moving of the display positions of the display data may be ended.

Note that, in the above description, the contour line 32 of the key information display region π and the borderlines EL1˜EL4 are circular, but the technique of the disclosure is not limited to this. For example, as illustrated as an example in FIG. 23, a contour line 32′ of a key information display region π′ and borderlines EL1′˜EL3′ may be polygonal.

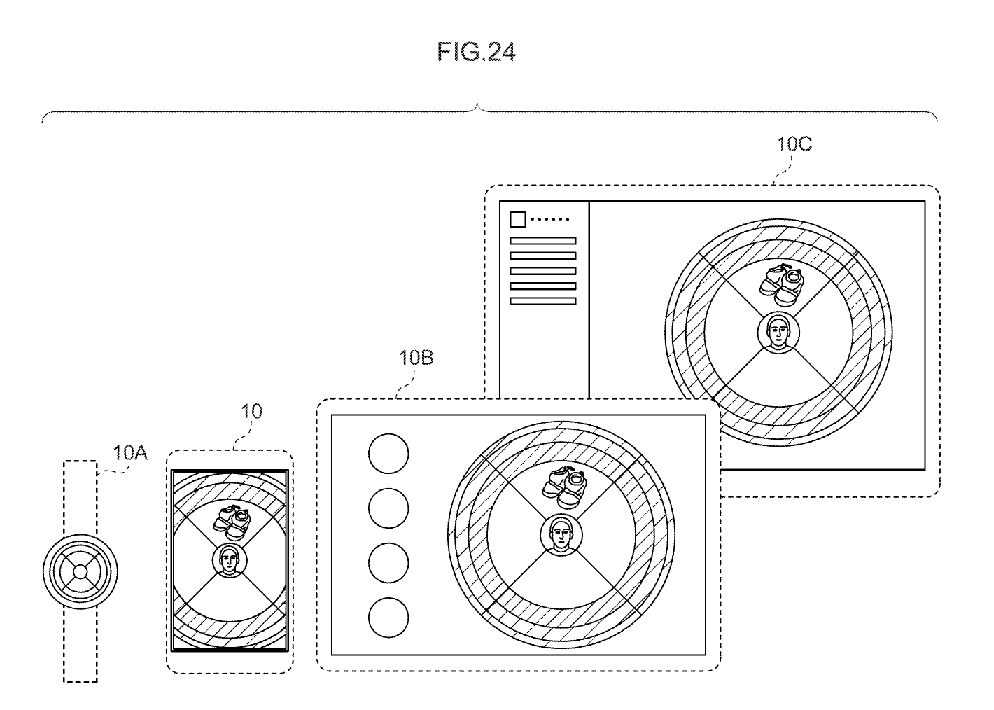

Note that, in the above description, explanation is given by using the smart device 10 as an example of the information processing device relating to the technique of the disclosure. However, the technique of the disclosure is not limited to this. For example, as illustrated in FIG. 24, the technique of the disclosure can be applied to various information processing devices such as a smart watch 10A, a tablet 10B, a desktop-type personal computer 10C, or the like.

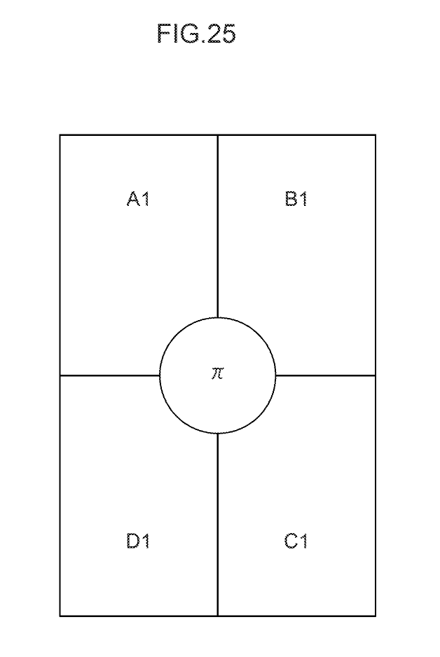

Note that, although the number of search result display regions per sectional region is made to be four in the above description, the technique of the disclosure is not limited to this. For example, in a case in which the size of the display is small such as the smart watch 10A or the like, as illustrated as an example in FIG. 25, the number of search result display regions per sectional region may be made to be one. Further, for example, in a case in which the size of the display is large such as the desktop-type personal computer 10C or the like, the number of search result display regions per sectional region may be made to be five or more.

Further, as illustrated as an example in FIG. 25, the directions in which the sectioning lines extend also may be arbitrary, but it is desirable that the angles of intersection between extension lines of the sectioning lines and extension lines of the sectioning lines adjacent to those sectioning lines be set so as to all be equal. This is because the impressions that the display data, that are displayed in the search result display regions that are displayed in the different sectional regions, give to the user thereby become the same.

Note that the above describes an example in which, even in a case in which the number of search result display regions per sectional region is set to be four, in a case that is immediately after start-up or immediately after searching or the like, only the display data, that relates to the search result whose search result ranking is the highest, is displayed with the number of search result display regions per sectional region being one. However, the technique of the disclosure is not limited to this. For example, even immediately after start-up or immediately after searching, four of the search result display regions may be displayed per sectional region, and display data, that relate to four search results that have arbitrary, consecutive search result rankings, may be displayed in the four search result display regions.

Note that, although the above describes an example in which searching is carried out and the display data that are the results of that search are displayed on a search result display screen, the technique of the disclosure is not limited to this. For example, the search result tables SRT and the search result management table 26 may be stored in the secondary storage section 64, and the search result display screen 30 may be displayed by using the data that are included in those search result tables SRT and search result management table 26. Further, the search result tables SRT and the search result management table 26 may be stored in the cloud, and the search result tables SRT and the search result management table 26 may be received from the cloud. The search result tables SRT and the search result management table 26 that are stored in the cloud may be reused by the information processing device that carried out the search or by a different information processing device. Further, the search result tables SRT and the search result management table 26 may be used in common by plural different information processing devices, and the search result tables SRT and the search result management table 26 may be received as needed.

Note that, in the above description, the types of searches are made to be four types because this is an amount that can be easily grasped by a person at one time. However, the technique of the disclosure is not limited to this. For example, the types of searches may be three types or may be five types. The number of sectional regions varies in accordance with the number of types of searches.

Note that the above gives the example of a text search, a similar image search, a recommended search and a similar user search as the types of searches, but the technique of the disclosure is not limited to this. For example, searching of events, that relate to a date that is included in the webpage indicated by the URL that is the key information, may be carried out.

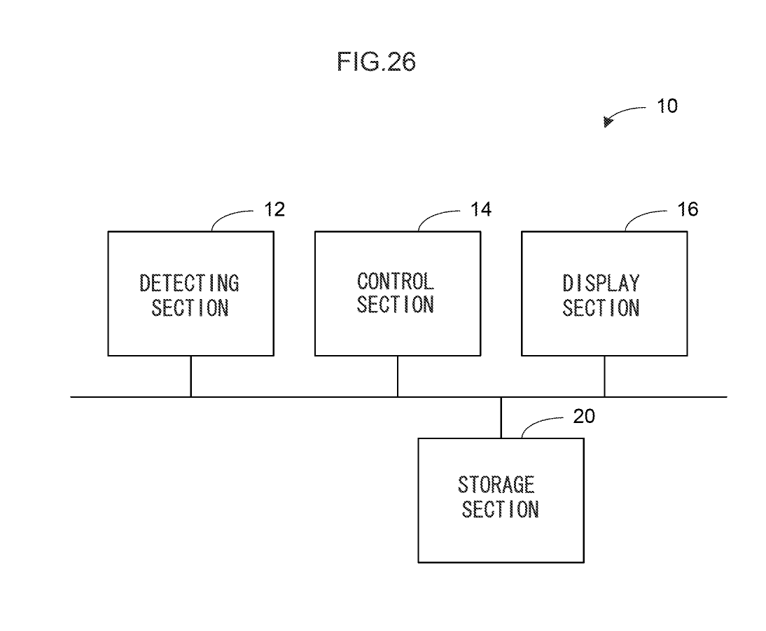

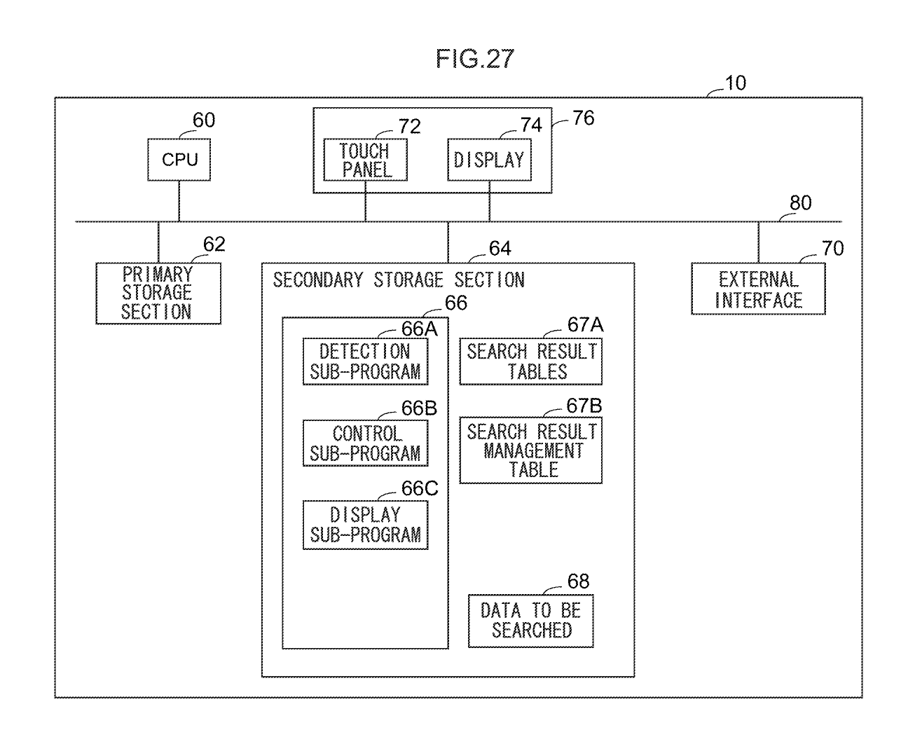

Note that the above describes a case in which searching is carried out from data on the internet by a search engine that is provided on the internet, but the technique of the disclosure is not limited to this. For example, by using the smart device 10 that is illustrated as an example in FIG. 26 and FIG. 27, searching may be carried out from data to be searched 68 that is stored in the secondary storage section 64 of the smart device 10 illustrated in FIG. 27. The difference between the smart device 10 that is illustrated as an example in FIG. 26 and the smart device 10 that is illustrated as an example in FIG. 1 is the absence/presence of the communication section 18. Further, the difference between the smart device 10 that is illustrated as an example in FIG. 27 and the smart device 10 that is illustrated as an example in FIG. 4 is the absence/presence of the data to be searched 68 and the communication sub-program 66D. The smart device 10 illustrated as an example in FIG. 26 and FIG. 27 does not use a search engine that is provided on the internet. Therefore, this smart device 10 does not have to have the communication section 18 and the communication sub-program 66D that are for transmitting instructions to a search engine and receiving search results from a search engine. For example, a case in which data to be searched is stored in advance in the secondary storage section of a smart device that is borrowed as a guide for a museum, an art museum, a library or the like, and the like can be envisaged. Further, a case of application to searching a large amount of music data or electronic book data or the like that an individual possesses, and the like can also be envisaged.

Note that description is given of displaying, in the key information display region π, an image that is extracted from a webpage indicated by a URL expressed by key information. However, the technique of the disclosure is not limited to this. For example, text data, URL data, or the like may be displayed instead of an image.

Note that, although an example is described in which description and images that are display data are displayed in the search result display regions A1˜A4, the technique of the disclosure is not limited to this. For example, the display data may be text data, or may be an icon for playing-back voice data or video data.

Note that description is given of an example in which, in the case of tapping on the search result display region in FIG. 7C, the image that is displayed in the search result display region is displayed in an enlarged manner as illustrated in FIG. 7D. However, the technique of the disclosure is not limited to this. For example, the search result display screen 30F that is illustrated in FIG. 7F may be displayed due to the search result display region being long-pressed or being double-tapped.

Further, although an example is described in which a webpage is displayed as illustrated in FIG. 7E due to the select button 46 of FIG. 7D being tapped, the technique of the disclosure is not limited to this. For example, the search result display screen 30F illustrated in FIG. 7F may be displayed due to the select button 46 of FIG. 7D being long-pressed or being double-tapped.

Further, by tapping on a back button 47 in FIG. 7D, it is possible to return to the search result display screen 30C of FIG. 7C. Further, the URL, from which was extracted the image that is displayed in the search result display region that is displayed in an enlarged manner, or the image that is displayed in the search result display region that is displayed in an enlarged manner, can be shared with another user by tapping on a share button 48. Further, by tapping on a back button 47′ in FIG. 7E, display can return to a screen 30D of FIG. 7D that includes the enlarged display of the image. Further, by tapping on a share button 48′, the URL of the displayed webpage can be shared with another user.

Note that the technique of the disclosure may be applied to searches of various types of data that are sensed by a temperature sensor, a humidity sensor, a GPS or the like that is installed in the smart device. For example, webpages that have images that were photographed at positions near the current position of the user that is sensed by a GPS, can be searched for. Further, the technique of the disclosure may be applied to the searching of data such as the usage history of a social networking service by the user, or the subscription history of news or the like, or the like. Further, for example, searching for webpages having an update time that is near to the time of execution of a search may be carried out. Due thereto, search results that better conform with the expectations of the user can be provided to the user.

Note that, although the above describes an example in which swiping operations in the vertical direction, swiping operations in the lateral direction, swiping operations in the forms of arcs, tapping operations and the like are used, the technique of the disclosure is not limited to this. In accordance with these operations, a user can intuitively operate the search result display screens. However, other touch operations, by which it is similarly possible for a user to operate the search result display screens intuitively, may be used.

Note that the above describes an aspect in which the search result display program 66 is stored in advance (installed) in the secondary storage section 64. However, the search result display program 66 can be provided in a form of being recorded on a non-transitory recording medium such as a CD-ROM or a DVD-ROM or the like. Further, the search result display program 66 may be stored on a remote server. For example, a smart device may receive, via a communication circuit such as the internet or the like, the results of execution of the search result display program 66 that are stored on a remote server, and may display the search result display screens of the technique of the disclosure on the display of the smart device.

In the technique of the disclosure, the display positions of the display data are changed in accordance with the vertical swiping of the user, so as to give the impression that the display data is pouring-out from the key information display region π or that the display data is being pulled-into the key information display region π. Due thereto, the key information and the plural search results that were retrieved on the basis of the key information can be displayed so as to be able to be collectively grasped in a short time. Further, the user can experience a sense of depth as if advancing or retreating in a tunnel, at a search result display screen that is displayed on a two-dimensional display.

Further, because the respective search result display regions display images as the information relating to the search results, the user can intuitively recognize the search results.

Further, in the technique of the disclosure, accompanying the swiping in the form of an arc by the user, the display data moves as if rotating clockwise or counterclockwise like a roulette wheel. Due thereto, in a case in which the user is operating the smart device with one hand, the user can rotatingly move the display positions of the display data to positions where operation is easy. Further, the user can rotatingly move the display positions of the display data to positions that are easy to see.

Further, in the technique of the disclosure, accompanying tapping by the user, a search whose key information has been changed is carried out, and the search results are provided to the user. Due thereto, the user can rapidly browse a large amount of display data relating to search results, without putting the search key into words or refining the search key. Further, due thereto, the user can enjoy searching freely as if skipping from provided information to provided information, and can experience the joy of discovery.

Further, in the technique of the disclosure, accompanying swiping in the lateral direction by the user, search results that are based on different key information are displayed. Due thereto, the user can easily browse the history of search results of searches that have been carried out on the basis of different key information.

As in the related art, for example, retrieved images are displayed so as to be lined-up in a vertical direction, and images, that are retrieved by using a key selected from a main image, are displayed so as to be lined-up in a lateral direction. Accordingly, the main image, and the large number of images retrieved by using the key selected from the main image, are always displayed apart from one another. In such a case, it is difficult to collectively grasp, in a short time, the main image and the plural images retrieved by using the key selected from the main image.

As one aspect, the technique of the disclosure enables key information, and plural search results that have been retrieved on the basis of the key information, to be displayed so as to be able to be grasped collectively in a short time.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory recording medium storing a search result display program that causes a computer, that has a first storage section that stores information in which rankings of search results, types of searches and search results are set in respective correspondence with one another, to execute a process, the process comprising:
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing, in the first storage section, search results of a plurality of types of searches that have been carried out on the basis of the key information;
displaying, in search result display regions of the sectional regions that correspond to types of searches, search results whose search result rankings are n, wherein n is an integer; and
in a state in which, in a sectional region s, search result display region t, wherein t is an integer, is disposed at a side opposite the key information display region side of search result display region t+1 along an arrayed direction of the plurality of search result display regions that are included in the sectional region s, and, in a state in which search result of ranking m, wherein m is an integer, is displayed in the search result display region t of the sectional region s, and search result of ranking m+1 is displayed in the search result display region t+1 of the sectional region s, when a first touch operation is detected, displaying the search result of ranking m+1, that was read-out from the first storage section, in the search result display region t of the sectional region s, and displaying search result of ranking m+2, that was read-out from the first storage section, in the search result display region t+1 of the sectional region s.

2. The non-transitory recording medium of claim 1, wherein the process further comprises:
in a state in which search result of ranking m is displayed in the search result display region t of the sectional region s, and search result of ranking m+1 is displayed in the search result display region t+1 of the sectional region s, when a second touch operation is detected, displaying search result of ranking m−1, that was read-out from the first storage section, in the search result display region t of the sectional region s, and displaying search result of ranking m, that was read-out from the first storage section, in the search result display region t+1 of the sectional region s.

3. The non-transitory recording medium of claim 1, wherein the first touch operation is a swiping operation or a flicking operation along a downward straight line.

4. The non-transitory recording medium of claim 2, wherein the second touch operation is a swiping operation or a flicking operation along an upward straight line.

5. The non-transitory recording medium of claim 1, wherein there are four of the sectional regions.

6. A non-transitory recording medium storing a search result display program that causes a computer, that has a first storage section that stores information in which rankings of search results, types of searches and search results are set in respective correspondence with one another, to execute a process, the process comprising:
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing, in the first storage section, search results of a plurality of types of searches that have been carried out on the basis of the key information;
displaying, in search result display regions of the sectional regions that correspond to types of searches, search results whose search result rankings are n, wherein n is an integer; and
in a state in which sectional region s+1, wherein s is an integer, is disposed at a clockwise advancing direction side of sectional region s, and sectional region s+2 is disposed at a clockwise advancing direction side of the sectional region s+1, and, in a state in which search results are respectively displayed in search result display regions of the sectional region s and the sectional region s+1, when a third touch operation is detected, displaying a search result, that was displayed in a search result display region of the sectional region s, in a search result display region of the sectional region s+1, and displaying a search result, that was displayed in a search result display region of the sectional region s+1, in a search result display region of the sectional region s+2.

7. The non-transitory recording medium of claim 6, wherein
sectional region s−1 is disposed at a counterclockwise advancing direction side of sectional region s, and the sectional region s is disposed at a counterclockwise advancing direction side of sectional region s+1, and
wherein the process further comprises, in a state in which search results are respectively displayed in search result display regions of the sectional region s and the sectional region s+1, when a fourth touch operation is detected, displaying a search result, that was displayed in a search result display region of the sectional region s, in a search result display region of the sectional region s−1, and displaying a search result, that was displayed in a search result display region of the sectional region s+1, in a search result display region of the sectional region s.

8. The non-transitory recording medium of claim 6, wherein the third touch operation is a clockwise swiping operation.

9. The non-transitory recording medium of claim 7, wherein the fourth touch operation is a counterclockwise swiping operation.

10. A non-transitory recording medium storing a search result display program that causes a computer, that has a first storage section that stores information in which rankings of search results, types of searches and search results are set in respective correspondence with one another, to execute a process, the process comprising:
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing, in the first storage section, search results of a plurality of types of searches that have been carried out on the basis of the key information;
displaying, in search result display regions of the sectional regions that correspond to types of searches, search results whose search result rankings are n, wherein n is an integer;
in a state in which search results of key information x, wherein x is an integer and expresses an order of searches, are displayed in search result display regions, when a fifth touch operation is detected, storing, in the first storage section, results of the plurality of searches carried out by using, as key information x+1, information relating to a search result displayed in a search result display region at which the fifth touch operation was detected;
displaying information relating to the key information x+1 in the key information display region; and
displaying search results of ranking p, wherein p is an integer, of the searches based on the key information x+1, in the search result display regions of the sectional regions corresponding to the types of searches.

11. The non-transitory recording medium of claim 10, wherein the fifth touch operation is a tapping operation.

12. A non-transitory recording medium storing a search result display program that causes a computer, that has a first storage section that stores information in which rankings of search results, types of searches and search results are set in respective correspondence with one another, to execute a process, the process comprising:
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing, in the first storage section, search results of a plurality of types of searches that have been carried out on the basis of the key information;
displaying, in search result display regions of the sectional regions that correspond to types of searches, search results whose search result rankings are n, wherein n is an integer; and
in a state in which search results of key information x, wherein x is an integer and expresses an order of searches, are displayed in search result display regions, when a sixth touch operation is detected, displaying, in the key information display region, information relating to key information x+1, and displaying, in the search result display regions, search results based on the key information x+1 that were read-out from the first storage section.

13. The non-transitory recording medium of claim 12, wherein the process further comprises:
in a state in which search results of key information x are displayed in search result display regions, when a seventh touch operation is detected, displaying, in the key information display region, information relating to key information x−1, and displaying, in the search result display regions, search results based on the key information x−1 that were read-out from the first storage section.

14. The non-transitory recording medium of claim 12, wherein the sixth touch operation is a swiping operation or a flicking operation along a rightward straight line.

15. The non-transitory recording medium of claim 13, wherein the seventh touch operation is a swiping operation or a flicking operation along a leftward straight line.

16. The non-transitory recording medium of claim 1, wherein
the search results are second search results that have been retrieved on the basis of the key information by an information processing device that is different from the computer, and
wherein the process further comprises receiving the second search results and storing the second search results in the first storage section.

17. The non-transitory recording medium of claim 1, wherein
information, in which rankings of search results, types of searches, and search results are set in respective correspondence with one another, is stored in a second storage section of an information processing device that is different from the computer, and
wherein the process further comprising receiving, from the information processing device, information in which rankings of search results, types of searches, and search results are set in respective correspondence with one another, and storing the information in the first storage section of the computer.

18. An information processing device comprising:
a first memory configured to store information in which rankings of search results, types of searches, and search results are set in respective correspondence with one another; and
a processor configured to execute a procedure, the procedure comprising:
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing, in the first memory, search results of a plurality of types of searches that have been carried out on the basis of the key information;
displaying, in search result display regions of the sectional regions that correspond to types of searches, search results whose search result ranking is n, wherein n is an integer; and
in a state in which, in a sectional region s, search result display region t, wherein t is an integer, is disposed at a side opposite the key information display region side of search result display region t+1 along an arrayed direction of the plurality of search result display regions that are included in the sectional region s, and, in a state in which search result of ranking m, wherein m is an integer, is displayed in the search result display region t of the sectional region s, and search result of ranking m+1 is displayed in the search result display region t+1 of the sectional region s, when a first touch operation is detected, displaying the search result of ranking m+1, that was read-out from the first memory, in the search result display region t of the sectional region s, and displaying search result of ranking m+2, that was read-out from the first memory, in the search result display region t+1 of the sectional region s.

19. The information processing device of claim 18, wherein the procedure further comprises, in a state in which search result of ranking m is displayed in the search result display region t of the sectional region s, and search result of ranking m+1 is displayed in the search result display region t+1 of the sectional region s, when a second touch operation is detected, displaying search result of ranking m−1, that was read-out from the first memory, in the search result display region t of the sectional region s, and displaying search result of ranking m, that was read-out from the first memory, in the search result display region t+1 of the sectional region s.

20. An information processing device comprising:
a first memory configured to store information in which rankings of search results, types of searches, and search results are set in respective correspondence with one another; and
a processor configured to execute a procedure, the procedure comprising:
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing, in the first memory, search results of a plurality of types of searches that have been carried out on the basis of the key information;
displaying, in search result display regions of the sectional regions that correspond to types of searches, search results whose search result ranking is n, wherein n is an integer, and
in a state in which sectional region s+1, s is an integer, is disposed at a clockwise advancing direction side of sectional region s, and sectional region s+2 is disposed at a clockwise advancing direction side of the sectional region s+1, and, in a state in which search results are respectively displayed in search result display regions of the sectional region s and the sectional region s+1, when a third touch operation is detected, displaying a search result, that was displayed in a search result display region of the sectional region s, in a search result display region of the sectional region s+1, and displaying a search result, that was displayed in a search result display region of the sectional region s+1, in a search result display region of the sectional region s+2.

21. The information processing device of claim 20, wherein
sectional region s−1 is disposed at a counterclockwise advancing direction side of sectional region s, and the sectional region s is disposed at a counterclockwise advancing direction side of sectional region s+1, and
wherein the procedure further comprising:
in a state in which search results are respectively displayed in search result display regions of the sectional region s and the sectional region s+1, when a fourth touch operation is detected, displaying a search result, that was displayed in a search result display region of the sectional region s, in a search result display region of the sectional region s−1, and displaying a search result, that was displayed in a search result display region of the sectional region s+1, in a search result display region of the sectional region s.

22. An information processing device comprising:
a first memory configured to store information in which rankings of search results, types of searches, and search results are set in respective correspondence with one another; and
a processor configured to execute a procedure, the procedure comprising:
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing, in the first memory, search results of a plurality of types of searches that have been carried out on the basis of the key information,
displaying, in search result display regions of the sectional regions that correspond to types of searches, search results whose search result ranking is n, wherein n is an integer; and
in a state in which search results of key information x, wherein x is an integer and expresses an order of searches, are displayed in search result display regions, when a fifth touch operation is detected, storing, in the first memory, results of the plurality of types of searches carried out by using, as key information x+1, information relating to a search result displayed in a search result display region at which the fifth touch operation was detected, displaying information relating to the key information x+1 in the key information display region, and displaying search results of ranking p, wherein p is an integer, of the searches based on the key information x+1, in the search result display regions of the sectional regions corresponding to the types of searches.

23. An information processing device comprising:
a first memory configured to store information in which rankings of search results, types of searches, and search results are set in respective correspondence with one another; and
a processor configured to execute a procedure, the procedure comprising:
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing, in the first memory, search results of a plurality of types of searches that have been carried out on the basis of the key information;
displaying, in search result display regions of the sectional regions that correspond to types of searches, search results whose search result ranking is n, wherein n is an integer; and
in a state in which search results of key information x, wherein x is an integer and expresses an order of searches, are displayed in search result display regions, when a sixth touch operation is detected, displaying, in the key information display region, information relating to key information x+1, and displaying, in the search result display regions, search results based on the key information x+1 that were read-out from the first memory.

24. The information processing device of claim 23, the procedure further comprising:
in a state in which search results of key information x are displayed in search result display regions, when a seventh touch operation is detected, displaying, in the key information display region, information relating to key information x−1, and displaying, in the search result display regions, search results based on the key information x−1 that were read-out from the first memory.

25. The information processing device of claim 18, wherein
the search results are second search results that have been retrieved on the basis of the key information by a computer that is different from the information processing device, and
wherein the procedure further comprises:
receiving the second search results and storing the second search results in the first memory.

26. The information processing device of claim 18, wherein
information, in which rankings of search results, types of searches, and search results are set in respective correspondence with one another, is stored in a second memory of a computer that is different from the information processing device, and
wherein the procedure further receiving, from the computer, information in which rankings of search results, types of searches, and search results are set in respective correspondence with one another, and storing the information in the first memory of the information processing device.

27. A search result displaying method comprising:
by a processor,
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing search results of a plurality of types of searches that have been carried out on the basis of the key information, in a first storage section and in respective correspondence with rankings of search results and types of searches;
displaying, in search result display regions of the sectional regions that correspond to types of searches, search results whose search result ranking is n, wherein n is an integer; and
in a sectional region s, search result display region t, t is an integer, is disposed at a side opposite the key information display region side of search result display region t+1 along an arrayed direction of the plurality of search result display regions that are included in the sectional region s, and, in a state in which search result of ranking m, wherein m is an integer, is displayed in the search result display region t of the sectional region s, and search result of ranking m+1 is displayed in the search result display region t+1 of the sectional region s, when a first touch operation is detected, displaying the search result of ranking m+1, that was read-out from the first storage section, in the search result display region t of the sectional region s, and displaying search result of ranking m+2, that was read-out from the first storage section, in the search result display region t+1 of the sectional region s.

28. A search result displaying method comprising:
by a processor,
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing search results of a plurality of types of searches that have been carried out on the basis of the key information, in a first storage section and in respective correspondence with rankings of search results and types of searches;
displaying, in search result display regions of the sectional regions that correspond to types of searches, search results whose search result ranking is n, wherein n is an integer; and in a state in which sectional region s+1, wherein s is an integer, is disposed at a clockwise advancing direction side of sectional region s, and sectional region s+2 is disposed at a clockwise advancing direction side of the sectional region s+1, and, in a state in which search results are respectively displayed in search result display regions of the sectional region s and the sectional region s+1, when a third touch operation is detected, displaying a search result, that was displayed in a search result display region of the sectional region s, in a search result display region of the sectional region s+1, and displaying a search result, that was displayed in a search result display region of the sectional region s+1, in a search result display region of the sectional region s+2.

29. A search result displaying method comprising:
by a processor:
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing search results of a plurality of types of searches that have been carried out on the basis of the key information, in a first storage section and in respective correspondence with rankings of search results and types of searches;
displaying, in search result display regions of the sectional regions that correspond to types of searches, search results whose search result ranking is n, wherein n is an integer;
in a state in which search results of key information x, wherein x is an integer and expresses an order of searches, are displayed in search result display regions, when a fifth touch operation is detected, storing, in the first storage section, results of the plurality of types of searches carried out by using, as key information x+1, information relating to a search result displayed in a search result display region at which the fifth touch operation was detected;
displaying information relating to the key information x+1 in the key information display region; and
displaying search results of ranking p, wherein p is an integer, of the searches based on the key information x+1, in the search result display regions of the sectional regions corresponding to the types of searches.

30. A search result displaying method comprising:
by a processor:
displaying on a display section a search result display screen that includes a key information display region that displays information relating to key information, and a plurality of sectional regions that are disposed at a periphery of the key information display region and that respectively include a plurality of search result display regions arrayed along radial directions that differ from one another;
storing search results of a plurality of types of searches that have been carried out on the basis of the key information, in a first storage section and in respective correspondence with rankings of search results and types of searches;
displaying, in search result display regions of the sectional regions that correspond to types of searches, search results whose search result ranking is n, wherein n is an integer; and
in a state in which search results of key information x, wherein x is an integer and expresses an order of searches, are displayed in search result display regions, when a sixth touch operation is detected, displaying, in the key information display region, information relating to key information x+1, and displaying, in the search result display regions, search results based on the key information x+1 that were read-out from the first storage section.
